(19) United States
(12) Patent Application Publication
(10) Pub. No.: US 2008/0262196 A1
(43) Pub. Date: Oct. 23, 2008

(54) APPARATUS AND METHOD OF SEPARATING A POLYMER FROM A SOLVENT

(75) Inventors: Mark Howard Giammattei, Selkirk, NY (US); Bernabe Quevedo Sanchez, Valladolid (ES); Narayan Ramesh, Evansville, IN (US); Norberto Silvi, Clifton Park, NY (US)

Correspondence Address: SABIC - 08CU - ULTEM;SABIC Innovative Plastics - IP Legal, ONE PLASTICS AVENUE, PITTSFIELD, MA, 01201-3697, US

(73) Assignee: SABIC INNOVATIVE PLASTICS IP BV, Pittsfield, MA (US)

(21) Appl. No.: 12/059,217

(22) Filed: Mar. 31, 2008

Related U.S. Application Data
(63) Continuation-in-part of application No. 11/298,365, filed on Dec. 8, 2005.
Application No. 11/298,365 is a continuation-in-part of application No. 11/144,141, filed on Jun. 3, 2005, now Pat. No. 7,122,619.
Application No. 11/144,141 is a continuation-in-part of application No. 10/648,524, filed on Aug. 26, 2003, now Pat. No. 6,949,622.

(51) Int. Cl. C08F 6/12; B29C 47/08; B29C 47/66

(52) U.S. Cl. 528/481; 528/480; 425/377

(57) ABSTRACT

The present invention relates to various embodiments of a system and method for separating polymer from a solvent. In one embodiment a system for separating polymer from a solvent comprises an extrusion apparatus includes a hollow member having a first end portion, a second end portion, and a feed port between the first end portion and the second end portion. The extrusion apparatus includes a back flash vent port disposed upstream of the feed port and a forward flash vent port disposed downstream of the feed port. The extrusion apparatus further includes a vent insert located at the forward flash vent port, a screw disposed inside the hollow member, and an internal superheating section disposed between the feed port and the downstream vent opening of the hollow member such that the length of the internal superheating section is greater than about four times the diameter, 4D, of the hollow member.

### CROSS-REFERENCE TO RELATED APPLICATIONS

This application is a Continuation-in-Part Application of U.S. patent application Ser. No. 11/298,365 filed Dec. 8, 2005, which is a Continuation-in-Part Application of U.S. patent application Ser. No. 11/144,141 filed Jun. 3, 2005, which is a Continuation Application of U.S. patent application Ser. No. 10/648,524, filed Aug. 26, 2003, all of which are incorporated herein in their entirety.

### BACKGROUND OF THE INVENTION

The preparation of polymeric materials is frequently carried out in a solvent from which the polymer product must be separated prior to molding, storage, or other such applications. This is the case in the manufacture of polyetherimide prepared by condensation polymerization of a dianhydride with a diamine in ortho-dichlorobenzene solution. Many other polymers are similarly prepared in solution and require a solvent removal step in order to isolate the polymer product. Illustrative polymers include interfacially-prepared polycarbonates, polysulfones, interfacially-prepared polycarbonate esters, and the like. The solvent frequently plays an indispensable role in polymer manufacture, providing for thorough mixing of reactants and for reducing the viscosity of the reaction mixture to provide for uniform heat transfer during the polymerization reaction itself. The solvent may further facilitate product purification by enabling the polymer product to be treated with water, aqueous acids and bases, and drying agents prior to solvent removal. Additionally, because a polymer solution is typically much less viscous than a molten polymer, the polymer solution is generally more easily filtered than the molten polymer.

Due to the pervasive use of solvent solutions in the manufacture or processing of polymeric material, there remains a need in the art to provide a convenient and cost-effective method and system to isolate a polymer from a polymer-solvent mixture.

The formation of blends or filled polymeric material may be effected by compounding a melt of the polymer with the additional polymer or filler. To prepare a polymer product having uniformly dispersed filler or to uniformly disperse an additional polymer, high shear rates, extended compounding and extruding times, and high heat may be required. The long residence times of compounding and high heat render the polymer product susceptible to discoloration and degradation of desired physical properties.

There also remains a need for an efficient and simple method to prepare a polymer product comprising uniformly dispersed filler.

### BRIEF SUMMARY OF THE INVENTION

The present invention herein provides for a system for processing polymer-solvent feed comprising an extrusion apparatus having a feed port for receiving polymer-solvent mixture, a back flash devolatilization portion of the extruder upstream of the feed port and a forward flash devolatilization portion downstream of the feed port for separating solvent from the polymer. The extrusion apparatus includes a hollow member having a diameter, D, the hollow member comprising a first end portion, a second end portion, and a feed port between the first end portion and the second end portion. The extruder apparatus includes back flash vent port disposed upstream of the feed port and a forward flash vent port disposed downstream of the feed port. The extrusion apparatus includes a screw disposed inside the hollow member extending from the first end portion to the second end portion of the hollow member. The forward flash devolatilization portion of the extrusion apparatus further includes an internal superheating section disposed between the feed port and the forward flash vent port of the hollow member, the internal superheating portion having a length that is greater than about four times the diameter of the hollow member. The extrusion apparatus further includes a vent insert located at the forward flash vent port of the hollow member.

In another embodiment the extrusion apparatus further includes a trace devolatilization portion downstream from the forward flash devolatilization portion wherein the screw comprises a surface renewal portion to generate relatively thin layers of the mixture of polymer and solvent to facilitate the removal of the last traces of solvent from the polymer. The length of the surface renewal section can depend upon several factors, such as for example, the length of the hollow member, the diameter of the screw, the feed rate and the particular polymer-solvent mix.

Also disclosed herein is a method for separating a polymer from a solvent to isolate a polymer product, the method comprising: introducing a polymer-solvent mixture, for example a superheated polymer-solvent mixture, into the feed port of an extruder apparatus which includes a screw disposed inside a hollow member, the hollow member having a downstream vent opening and an upstream vent opening, and passing the polymer-solvent mixture through an internal superheating section of the extruder apparatus which is at least about four times the diameter, 4D, of the hollow member and wherein the extruder apparatus is operated at a devolatilization performance ratio (DPR) which ranges from about 0.01 to about 200 to correlate with at least one target characteristic of the polymer product. The devolatilization performance ratio is the feed rate (FR) divided by the screw speed (RPM) according to Equation (I):

DPR=FR/RPM Equation (I)

In yet another embodiment, a method of preparing a filled polymer comprises introducing a superheated polymer-solvent mixture to the extruder of the apparatus described above, and wherein the superheated polymer-solvent mixture comprises a filler; removing solvent from the superheated polymer-solvent mixture via the back flash vent port and the forward flash vent port; dispersing the filler uniformly into the polymer matrix; and isolating a filled polymer from the polymer-solvent mixture.

### DESCRIPTION OF THE DRAWINGS

The various embodiments of the present invention can be understood by the following drawings and figures. The components are not necessarily to scale.

FIG. 1 is a system for separating a polymer-solvent mixture, the system comprising a feed system and an extrusion apparatus comprising a main extruder having back flash devolatilization portion, a forward flash devolatilization portion, and a trace devolatilization portion, according to the embodiment of the present invention;

FIG. 2 is a schematic side view of the extruder apparatus of FIG. 1 showing the screw designs within the back flash devolatilization portion, the forward flash devolatilization portion, a trace devolatilization portion and the vent ports, according to an embodiment of the present invention;

FIG. 3 is a top view of the twin-screw extruder apparatus of FIGS. 1 and 2 illustrating the side feeder screws which flow into the main screw, according to an embodiment of the present invention;

FIG. 4 is a schematic end view of the extrusion line of FIG. 1 showing the side feeder extruders equipped with at least one vent box positioned below the side feeder screws and each vent box has a polymer/solvent mix drain, according to an embodiment of the present invention;

FIG. 5 is a schematic end view of the extrusion line of FIG. 4 showing the side feeder screws are further equipped with at least one vent box positioned above the side feeder screws and each vent box has a polymer/solvent mix drain and a solvent vapor line, according to an embodiment of the present invention;

FIG. 6 is an axial cross-sectional view of the extruder apparatus of FIG. 2 of a vent insert positioned in a vent port and a vent port cleaning device attached to the vent insert, according to an embodiment of the present invention;

FIG. 7 is a longitudinal cross sectional view taken along lines 7-7 of the vent insert of FIG. 6 and showing the vent insert proximate a screw, according to an embodiment of the present invention;

FIG. 8 is a top view taken along the plane 8-8 above the vent insert of FIG. 6 showing the opening of the vent insert and screw of the extruder apparatus, according to an embodiment of the present invention;

FIG. 9 is a top view schematic representation of the extruder apparatus shown in FIG. 2, according to an embodiment of the present invention;

FIG. 10 is a top view of an alternative extruder apparatus, according to an embodiment of the present invention;

FIG. 11 is schematic side view of the extruder apparatus of FIG. 10 showing the screw design and vent openings, according to an embodiment of the present invention; and

FIG. 12 is a graph plot showing the level of residual in the polymer as a function of the devolatilization performance ratio.

### DETAILED DESCRIPTION OF THE INVENTION

The present invention provides various embodiments of a system and method for separating polymer-solvent mixtures into their polymer and solvent components at high yields, for example, yields of at least about 80%, in another embodiment at least about 90%, and in another embodiment at least about 95% and low levels of solvent residuals. The system comprises an extrusion apparatus having a forward flash devolatilization portion comprising an internal superheating section which is increased in length. In an alternative embodiment, the extrusion apparatus further includes a trace devolatilization section wherein the screw has a surface renewal portion and optionally, at least one vent port which facilitates removal of solvent under vacuum.

Disclosed herein are methods. Also disclosed are systems for effecting the separation of polymer-solvent mixtures. Finally, a method of preparing a polymer product comprising uniformly dispersed filler is disclosed. The singular forms “a,” “an,” and “the” include plural referents unless the context clearly dictates otherwise.

“Optional” or “optionally” means that the subsequently described event or circumstance may or may not occur, and that the description includes instances where the event occurs and instances where it does not.

As used herein, the term “substantially all” means 95 percent or more. As used herein, a polymer “substantially free of solvent” contains less than about 5000 parts per million solvent.

As used herein, the term “solvent” can refer to a single solvent or a mixture of solvents.

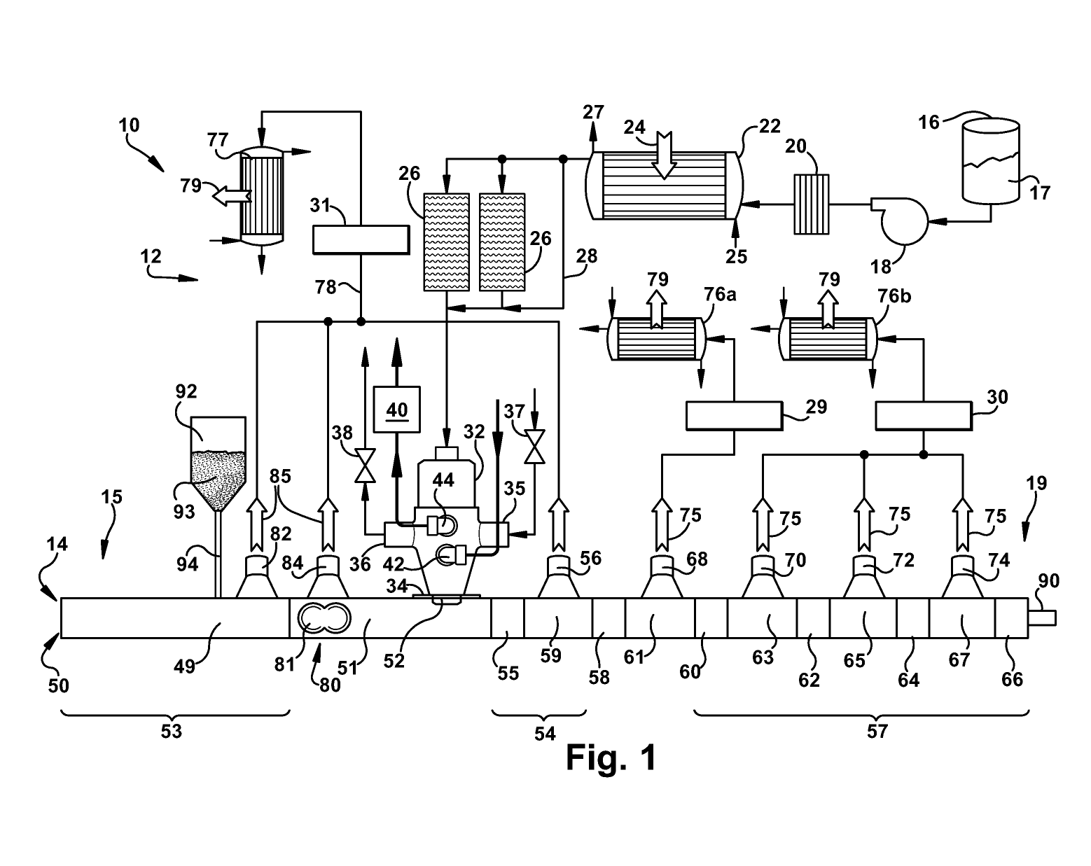

FIG. 1 illustrates an example embodiment of a system or apparatus 10 for separating polymer from a mixture. Apparatus 10 includes a feed delivery system 12 and an extruder apparatus 14 which separates polymer from a polymer-solvent mixture which is fed into the extruder apparatus 14. Typically polymer-solvent mixtures are solutions, which comprise one or more polymers dissolved in one or more solvents. Alternatively, a polymer-solvent mixture may be one or more solvents dissolved in one or more polymers, for example, in a polyetherimide containing ortho-dichlorobenzene (ODCB), or polyetherimide-polyphenylene ether containing ODCB. Also contemplated as polymer-solvent mixtures are polymer and solvent and further including a filler and/or an additive. The polymer-solvent mixture that is introduced into the extruder comprises a solvent and a polymer, wherein the amount of polymer is less than or equal to about 99 weight percent based on the total of polymer and solvent. Within this range the amount of polymer may be less than or equal to about 75 weight percent, with less than or equal to about 60 more preferred, and less than or equal to about 50 weight percent based on the total of polymer and solvent more preferred. Also within this range, the weight percent of polymer may be greater than or equal to about 5, in another embodiment greater than or equal to about 20, and in another embodiment, greater than or equal to about 30 weight percent based on the total of polymer and solvent.

The polymer-solvent mixture may comprise a wide variety of polymers. Exemplary polymers include polyetherimides, polycarbonates, polycarbonate esters, poly(arylene ether)s, polyamides, polyarylates, polyesters, polysulfones, polyetherketones, polyimides, olefin polymers, polysiloxanes, poly(alkenyl aromatic)s, and blends comprising at least one of the foregoing polymers. In instances where two or more polymers are present in the polymer-solvent mixture, the polymer product may be a polymer blend, such as a blend of a polyetherimide and a poly(arylene ether). Other blends may include a polyetherimide and a polycarbonate ester. It has been found that the pre-dispersal or pre-dissolution of two or more polymers within the polymer-solvent mixture allows for the efficient and uniform distribution of the polymers in the resulting isolated polymer product matrix. Further details regarding the polymer-solvent mixture are described below.

In one embodiment the polymer-solvent mixture is heated prior to being fed into the extruder. The feed delivery system 12 can include a heated feed tank 16 for supplying a polymer-solvent mixture 17, a gear pump 18 for pumping the mixture through a flow meter 20 and heat exchanger 22. The heat exchanger 22 provides heat energy indicated by arrow 24 to provide a super heated polymer-solvent mixture which is forced by the action of the gear pump through in-line filters 26. For example, a cross-flow heating fluid enters the heat exchanger 24 as indicated by arrow 25 and exits as indicated by arrow 27 to heat the polymer-solvent mixture 17. The optional in-line filters 26 remove particulate impurities from the super heated polymer-solvent mixture before the polymer-solvent mixture passes into the extruder apparatus 14.

The polymer-solvent mixture may be filtered prior to and/or after heating or superheating to a temperature greater than the boiling point of the solvent. An example of a solution filtration system is an in-line metal filter. Alternatively, the extruder may optionally comprise a melt filtration system for filtering the polymer melt in the extruder. The feed delivery system 12 of apparatus 10 also includes a pressure control valve, or a feed valve 32. A feed valve is used at the end of the feed delivery system of the extruder to separate the high from the low pressure zones from the process. The feed valve 32 can be operated mechanically or electronically and can open upon demand. For example, demand can occur when the incoming pressure that is generated when the process feed pump reaches a predetermined set point pressure. Also, the degree to which the valve opens can vary and can be based on the feed rate, Kg/hr of the feed pump and opens enough to deliver the pre-determined rate. If the incoming liquid pressure is reduced below a predetermined set point pressure, the feed valve 32 closes. The feed valve then will reopen when the pump re-establishes pressure that is sufficient to lift a piston and resume feed. For example the feed valve can include a component which can be mechanically adjusted, for example a pressure spring pre-load adjuster which determines at which pressure the valve will open. Such a component can be an external adjustment that can be changed depending on the process.

Feed valve 32 includes a body 32 and a flange portion 34 which mounts onto the top of the extruder apparatus. The feed valve receives polymer-solvent mix through the inlet 35 and the feed valve can optionally further heat the polymer-solvent mixture as it exits the outlet 36. If the polymer-solvent mixture has not attained the desired temperature the polymer-solvent mixture exits outlet port 36 and flows through valve 38 and circulates back to the feed tank 16, for example. Therefore the polymer-solvent mix can be re-circulated until it achieves a proper predetermined temperature at which point the polymer-solvent mix flows to the extruder apparatus 14 through feed port 52.

Optionally, a heated liquid supply loop can accompany the feed valve 32. The polymer-solvent mixture can be further heated when the feed valve 32 includes an energy source, for example a heated fluid medium. In such case the feed valve 32 can optionally include an inlet 44 and an outlet 42 for circulating the fluid medium through the flash valve and to a heat source 40 before the fluid medium returns to the flash valve. In addition, the feed valve 32 can further include insulation (not shown), to retain the heat and temperature of the feed valve. A heated feed valve can help insure that the feed valve is maintained at a proper predetermined temperature to reduce or eliminate solid material accumulation. The incoming polymer-solvent mix helps to flush and effectively to heat the valve more uniformly to provide additional relief from material sticking and/or accumulation during start up.

In one example embodiment the feed valve 32 pressure control valve is a close-coupled flash valve. A close-coupled flash valve has an added advantage in that it functions to keep the polymer-solvent mixture heated to the desired temperature and pressure for injecting into the extruder apparatus 14, or alternatively, can route the mixture to the a heat source to attain a desired temperature before the mixture is injected into the extruder apparatus 14. Close-coupled flash valves are commercially available. A suitable close-coupled flash valve, for example, can be designed and purchased from commercial vendors such as by Schuf, Inc.

In another embodiment the polymer-solvent mixture is introduced into an evaporator or distillation apparatus (not shown) to concentrate the polymer-solvent mixture prior to its introduction to the extruder. The evaporator or distillation apparatus can be upstream from the extruder apparatus 14 and in direct communication with the feed valve 32 attached to the extruder.

Still referring to FIG. 1, the extruder apparatus 14 includes hollow member 50 which has a feed port 52 and a screw system which extends from the first end portion 15 of the hollow member 50 to the second end portion 19 of the hollow member. The length of the hollow member 50 ranges from about 20 times the diameter, 20D, to about 60 times the diameter, 60D, of the hollow member.

The extruder apparatus 14 includes a back flash devolitalization portion 53 upstream of the feed port 52, a forward flash devolatalization portion 54 downstream of the feed port of the extruder apparatus. In another embodiment the extruder apparatus 14 also includes a trace devolatilization portion 57.

The hollow member 50 of extruder apparatus 14 may and screw, etc. of extruder apparatus 14 may be one of many sizes as long as it is configured to provide sufficient volume for flash evaporation of the solvent as well as the downstream devolatilization of remaining solvent. The screw can include, but is not limited to, a single-screw, a twin-screw such as, a counter-rotating twin-screw, a co-rotating twin-screw, a co-rotating intermeshing twin-screw, for example.

The hollow member 50 can be solid single barrel or can include two or more segmented barrels. As shown, various portions of hollow member 50 can be open or closed. For example hollow member 50 includes open sections 49, 51, 59, 61, 63, 65 and 67, and closed sections 55, 58, 60, 62, 64 and 66.

The forward flash devolatilization portion 54 of the extruder apparatus includes an internal superheating section 55 and a forward flash vent 56 disposed between the feed inlet 52 and the forward flash vent 56. The internal superheating section 55 has a length that is greater than about four times the diameter, 4D, of the hollow member, in another embodiment, the length of the internal superheating section ranges from greater than about four times the diameter, 4D, of the hollow member to about 12 times the diameter, 12D, and in another embodiment, the length can range from about five times the diameter, 5D, to about six times the diameter, 6D, of the hollow member 50. Forward flash vent port 56 can be sufficiently downstream of the feed inlet to effect the forward flash devolatilization process.

In another embodiment, the extruder apparatus 14 further includes a back flash vent, for example back flash vents ports 82 and 84, upstream of the feed port 52 to effect the back flash devolatilization process. A varied number of vents either downstream or upstream of the feed port 52 are also contemplated herein. Back vents ports can be located either on the extruder barrel or on the side feeders orthogonally connected to the extruder barrel as will be further described.

In another of the downstream portion of the extruder apparatus 14 further includes a trace devolatilization portion 57 downstream of the forward flash vent port 56. The trace devolatilization portion 57 of the extruder apparatus comprises at least one surface renewal section, and at least one trace devolatilization vent port, for example trace devolatilization vent ports 68, 70, 72 and 74. Vent ports 68, 70, 72, and 74 provide for the removal of solvent which is not removed through the upstream vents, for example the back flash vent ports 82 and 84, and the forward flash vent port 56.

Solvent vapors 75 which flow through forward flash vent port 68 is shown as flowing through a solvent-vapor manifold 29 and being condensed at condenser 76a, and solvent vapors which flow through trace devolatilization vent ports, 70, 72 and 74 are shown flowing through a solvent-vapor manifold 30 and are condensed and recovered at condenser 76b. The back flash devolatilization portion 53 of extruder apparatus 14 includes at least one vent opening, for example back flash vent ports 82 and 84 in which solvent vapors are condensed and recovered at condenser 77 where heat is removed and indicated by arrow 79. Extruder apparatus 14 is optionally equipped with a side feeder 80 which is in communication with hollow member 50 at opening 81. In one embodiment, manifold 29 and 31 which recover the vapors from the forward flash and back flash portions 53 and 54 of the extruder apparatus, respectively, are operated at pressure that ranges from about 700 millimeters of mercury (mm of Hg) to about 800 m, in another embodiment, from about 740 to about 780 millimeters of mercury (mm of Hg), and in another embodiment, about atmospheric pressure. Manifold 30 which recovers solvent from the trace devolatilization portion 57 of the extruder apparatus 14, respectively, are operated at pressure that ranges from greater than zero to about 400 millimeters of mercury (mm of Hg), in another embodiment, from about greater than zero to about 100 millimeters of mercury (mm of Hg), and in another embodiment, from about 5 millimeters of mercury (mm of Hg) to about 50 millimeters of mercury (mm of Hg).

In another embodiment, the system or apparatus 10 can optionally include a purge delivery system which is mounted onto hollow member 50 in the upstream portion 53 of the extruder apparatus 14. The purge delivery system can be located at an open section, for example open section 49, of the hollow member 50, wherein the hollow member has an opening for receiving purging material from the purge delivery system. The purge delivery system can include a hopper 92 which contains pellets of purge polymer 93 and a feeder 94 to admit the pellets into the extruder. It mounts onto the hollow member in the upstream portion of the extruder. When the process for separating a polymer-solvent mixture 17 is complete, then the purge delivery system delivers purge polymer 93 which has a lower melt temperature than the polymer of the polymer-solvent mixture, through hollow member 50 during shutdown to facilitate smoother restart of operations.

Therefore, in one embodiment, the present invention herein provides for a system for processing polymer-solvent feed which includes an extrusion apparatus comprising a hollow member having a diameter, D, the hollow member having a feed port disposed between a first end portion and a second end portion, and a screw disposed inside the hollow member extending from the first end portion to the second end portion of the hollow member. The hollow member also includes a back flash vent port disposed upstream of the feed port and a forward flash vent port disposed downstream of the feed port. The extrusion apparatus further includes a vent insert located at the forward flash vent port of the hollow member, and an internal superheating section disposed between the feed port and the forward flash vent port of the hollow member, the internal superheating section having a length that is greater than about four times the diameter, 4D, of the hollow member. In another embodiment, the length of the internal superheating section ranges from about four times the diameter, 4D, of the hollow member to about 12 times the diameter, D, and in another embodiment, the length can range from about five times the diameter, 5D to about six times the diameter, 6D, of the hollow member 50.

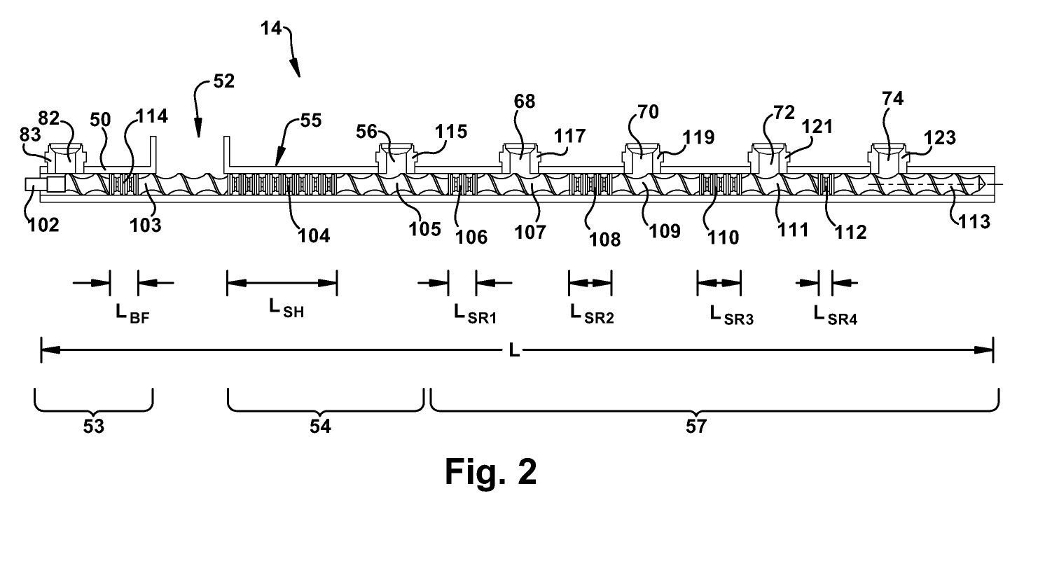

FIG. 2 is a longitudinal cross-sectional view of extruder apparatus 14 of FIG. 1 showing feed port 52 which divides the back flash devolatilization portion 53 and the forward flash devolatilization portion 54 of the extruder apparatus 14. The optional trace devolatilization portion 57 is also shown downstream of the forward flash devolatilization. At least a portion of the screw elements in each of regions of the extrusion apparatus includes kneading elements which are distinguished from the conveying elements which push the polymer material downstream. It has been found herein that the presence and the length of these kneading elements affect, at least in part, affects the yield of separation of the polymer-solvent mixtures into their polymer and solvent components, for example, yields of at least about 80%, in another embodiment at least about 90%, and in another embodiment at least about 95% and low levels of solvent residuals as will be further described.

The screw portions in the back flash devolatilization section 53 have conveying elements, for example screw portion 103, that provide sufficient internal cross section to accommodate the relatively large volume of solvent vapors produced by the disengagement of the superheated solvent from the polymer-solvent solution, and also kneading elements 114 which intercept small polymer particles entrained with the fast moving vapors thus preventing the removal of these particles from the extruder through the back vents operated at atmospheric pressure.

The forward flash devolatilization 54 portion of extruder apparatus 14 includes an internal superheating section 55 and forward flash vent 56. The screws in the forward flash devolatilization section 54 can contain a combination of kneading blocks 104 of the internal superheating section 55 and conveying elements 105. The screw portion or kneading blocks 104 of the superheating section 55 can include narrow and wide-disk kneading elements, for example, which replenish the heat of vaporization removed from the mixture in the back flash section, and also convey the devolatilized mixture away from the feed inlet so more incoming solution can be accommodated in the cross section of the extruder. The kneading blocks 104 may also be neutral kneading blocks which can be made of 90-degree staggered disks, for example, used in this section where the internal super-heating of the mixture of molten polymer and solvent takes place.

In another embodiment the extruder apparatus further includes a trace devolatilization portion 57 which includes at least one surface renewal section 58 (FIG. 1) and at least one trace devolatilization vent opening 68 downstream of the surface renewal section. The trace devolatilization vent port 68 operates at a lower pressure than the forward flash vent port 56 to remove the residual solvent present with the polymer. The surface renewal section 58 includes surface renewal screw elements 106 and can operates as a dynamic viscous seal between the two pressure zones of the forward flash vent port 56 and the trace devolatilization vent port 68 of the extruder and can include, for example, right-handed conveying elements of tight pitch as well as left-handed kneading elements, that stand in opposition to the flow of polymer, so material can be pushed against the wall of the extruder thus generating relatively high dynamic pressures. Therefore, the trace devolatilization portion of the screw contains a combination of conveying elements and kneading blocks, for example, wide-disk kneading blocks and narrow-disk kneading blocks to enhance the generation of liquid-vapor interfacial area while keeping the dissipation of viscous heat to a minimum. The section of the screw that is located immediately upstream of the die plate contains conveying elements of tight pitch that generate the necessary pressure for the devolatilized melt to be pumped out of the extruder.

As mentioned above, the present invention provide for various embodiments of the extruder apparatus and method in which the polymer and solvent can be efficiently separated from one another. The length of these kneading elements in the various regions, relative to the overall length, L, of the screw has bearing on the efficiency. In one embodiment the length of the internal superheating section, L_{SH} ranges from about 6% to about 25% of the overall length, L, of the screw. In another embodiment, the length of the internal superheating section, L_{SH}, ranges from about 9% to about 12% of the overall length, L, of the screw. In addition, the internal superheating section comprises kneading elements having a combined length ranging from 50 to 95%, alternatively from 55% to 90%, of the distance between the feed port 52 and the forward flash vent 56.

In another embodiment the length of the kneading elements L_{BF} in the back flash devolatilization portion of the extruder apparatus ranges from about 3% to about 10% of the overall length, L, of the screw, in another embodiment the kneading elements range from about 3% to about 8% of the overall length, L.

It has been found that additional kneading elements downstream of the internal superheating section, in the trace devolatilization portion of the extruder apparatus 14, can improve the efficiency of the separation of polymer from the solvent. In one embodiment the combined length of the surface renewal sections, for example the combined length of L_{SH1}, L_{SH2}, L_{SH3}, L_{SH4}, of the trace devolatilization portion can ranges from about 1% to about 54% of the overall length, L, of the screw, in another embodiment from about 10% to about 25% of the overall length, L, of the screw. The length of any particular surface renewal section ranges from about 0.5% to about 6% of the overall length, L, of the screw and in another embodiment from about 1% to about 5% of the overall length, L, of the screw. In another embodiment, the combined length of at least one surface renewal sections ranges from about 0.5 times the diameter of the hollow member, D to about 30 times the diameter of the hollow, D, member.

Therefore, FIG. 2 shows that screw 102 has forward conveying sections 103, 105, 107, 109, 111 and 113. Screw 102 also includes kneading elements, for example kneading elements 104 of super heating section 55 and kneading elements 106, 108, 110 and 112 of surface renewal sections in the trace devolatilization portion of the extruder. Vent ports 56, 68, 70, 72 and 74 include vent inserts 115, 117, 119, 121 and 123, respectively.

The pressure at the various vent ports differ. The pressure of the back flash vent port 82 and the forward flash vent port 56 ranges from about 700 to about 800 millimeters of mercury (mm of Hg), in another embodiment from about 750 to about 770, and in yet another embodiment a pressure that is about atmospheric pressure, about 760 millimeters of mercury (mm of Hg), or slight vacuum. The at least one trace devolatilization vent port, for example trace devolatilization vent ports 68, 70, 72 and 74 when present, can be operated at a vacuum to can have a pressure which ranges from greater than zero to about 400 millimeters of mercury (mm of Hg). In another embodiment the pressure of the vent ports decrease as the polymer moves downstream through the extruder apparatus. For example, trace devolatilization port 68 may operate at a medium vacuum which ranges from about 100 to about 400 millimeters of mercury (mm of Hg), in another example from about 50 millimeters of mercury (mm of Hg) to about 100 millimeters of mercury (mm of Hg), and vacuum ports 70, 72, and 74 may operate at a deep vacuum that ranges from greater than zero to about 100 millimeters of mercury (mm of Hg), and in another embodiment from about 5 millimeters of mercury (mm of Hg) to about 30 millimeters of mercury (mm of Hg), for example.

The hollow member 50 includes at least one screw 102 however a plurality of screws are possible. The extruder hollow member 50 may include any number or type of screw elements, etc. as long as it is configured to provide sufficient volume for fresh evaporation of the solvent as well as the downstream devolatilization of remaining solvent. Therefore, polymer-solvent mixture may be fed into a vented extruder configured to have sufficient volume to permit efficient flash evaporation of solvent from the polymer-solvent mixture, for even very dilute solutions. The feed inlet through which the polymer-solvent mixture is fed to the feed zone of the extruder may be in close proximity to a back flash vent port, for example vent 84 upstream of the feed inlet, can be used to effect the bulk of the solvent removal. The upstream vent may be operated at various pressures such as, for example, atmospheric or subatmospheric pressures described above. The extruder, the feed inlet, and the back flash vent port are configured to provide the volume needed to permit efficient flash evaporation of solvent from the polymer-solvent mixture. A vent located downstream of the feed inlet of the extruder, for example the forward flash vent port 68 and the trace devolatilization vent ports 68, 70, 72 and 74 as described above, may run at atmospheric pressure, but also at subatmospheric pressure as described above.

In one embodiment the superheated polymer-solvent mixture passes through the feed valve 30, i.e. a pressure control valve, and into the feed inlet 52 of the extruder, which due to the presence of the aforementioned vents (upstream extruder vent and/or side feeder vent described further below) may be at atmospheric pressure. The solvent present in the superheated polymer-solvent mixture undergoes sudden and rapid evaporation thereby effecting at least partial separation of the polymer and solvent, the solvent vapors emerging through the upstream vents. Additionally, the extruder is equipped with at least one downstream vent operated at subatmospheric pressure, which serves to remove solvent not removed through the upstream vent and/or side feeder vent. One downstream vent may be used, but preferably at least two downstream vents are used. Generally, from about 50 to about 99 percent, preferably from about 90 to about 99 percent of the solvent present in the initial polymer-solvent mixture is removed through the upstream vent and/or side feeder vent and a substantial portion of any solvent remaining is removed through the downstream vent operated at subatmospheric pressure.

The vent operated at about atmospheric pressure, whether it is an upstream vent or a side feeder vent, is operated at the pressure of the surroundings (in the absence of an applied vacuum), typically about 750 millimeters of mercury (mm of Hg) or greater.

The vent operated at subatmospheric pressure, whether it is an upstream vent, side feeder vent, or downstream vent, may be maintained at less than or equal to about 750 millimeters of mercury (mm of Hg), preferably about 1 to about 750 mm Hg as measured by a vacuum gauge. Within this range, the vent may be operated at greater than or equal to about 100 mm, preferably greater than or equal to about 250 mm and even more preferably greater than or equal to about 350 mm of mercury. Also within this range the vents may be operated at less than or equal to about 600 mm, preferably less than or equal to about 500 mm, and more preferably less than or equal to about 400 mm of mercury of vacuum.

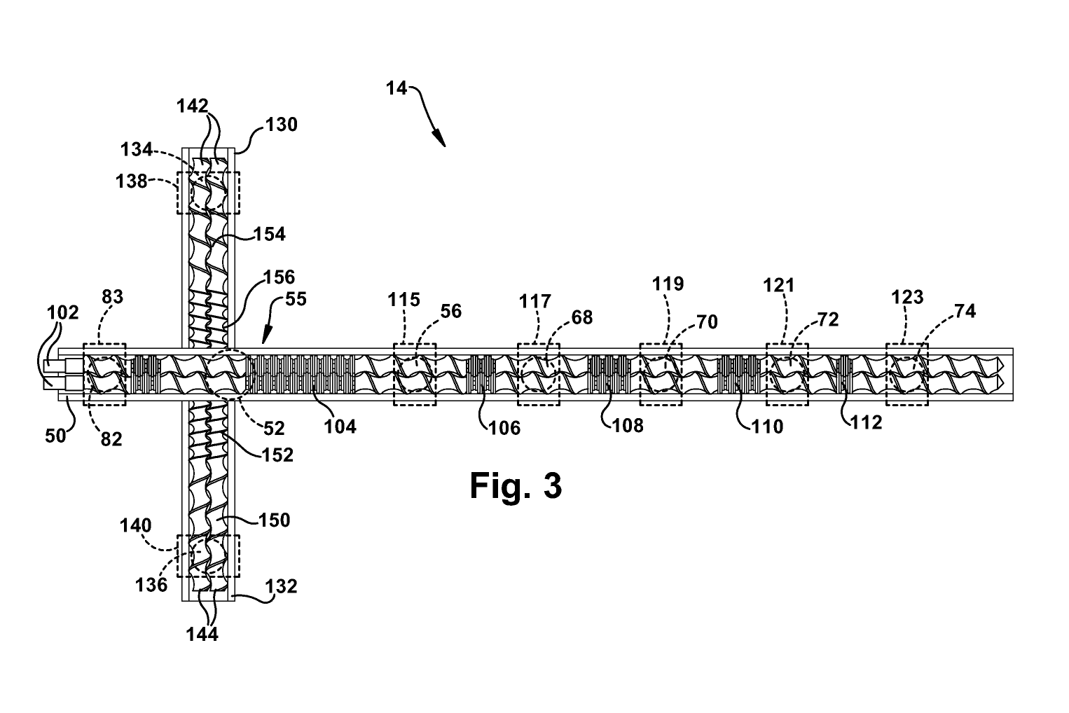

FIG. 3 is a top view cross section illustration of the extruder apparatus 14 of FIGS. 1 and 2 showing a view of the main extruder and side feeders. Extruder apparatus 14 includes twin-screw 102 main extruder hollow member 50 and side feeders 130 and 132. Feed inlets 52 is shown in close proximity to the side feeders 130 and 132. It has been found advantageous that the side feeder 130, 132 comprise a vent opening, for example vent openings 134 and 136 which entrain the solvent through vent boxes 138 and 140 respectively, or optionally through vent inserts. The side feeder screws, for example 142 and 144 comprise at least one vent to aid in the removal of solvent from the polymer-solvent mix. The side feeders 130, 132 can be positioned orthogonally and in close proximity to the feed port 52 through which the polymer-solvent mixtures introduced into the extruder apparatus 14, and preferably upstream from the feed port 52.

In one embodiment the side feeder vent ports 134 and 136 are operated at about atmospheric pressure or sub-atmospheric pressure. In an alternative embodiment, a side feed inlet port (not shown) may be attached to the side feeder itself in which instance the side feeder feed inlet is attached to the side feeder at a position between the point of attachment of the side feeder to hollow member 50 and the side feeder vent. And yet in a another example embodiment, the polymer-solvent mixture may be introduced through side feed inlet ports (not shown) of the side feeders 130, 132, the hollow member 50, or to both hollow member 50 and the side feeders 130, 132. The side feeder screws 142 and 144 include conveying elements 150, 152, 154 and 156 which serve to transport deposited polymer into the extruder hollow member 50.

In another embodiment the superheated polymer-solvent mixture 17 (FIG. 1) is introduced through multiple pressure control or feed valves located on hollow member 50 of the extruder apparatus and also on the side feeder. In one embodiment, one feed valve can communicate directly with the feed port 52 of the extruder, for example, attached directly to the extruder, and a second feed valve can communicate with hollow member 50 via the side feeder. Alternatively, it is possible to have a system in which there is no feed valve in direct communication with the hollow member 50, having instead multiple side feeders each of which is equipped with at least one feed valve.

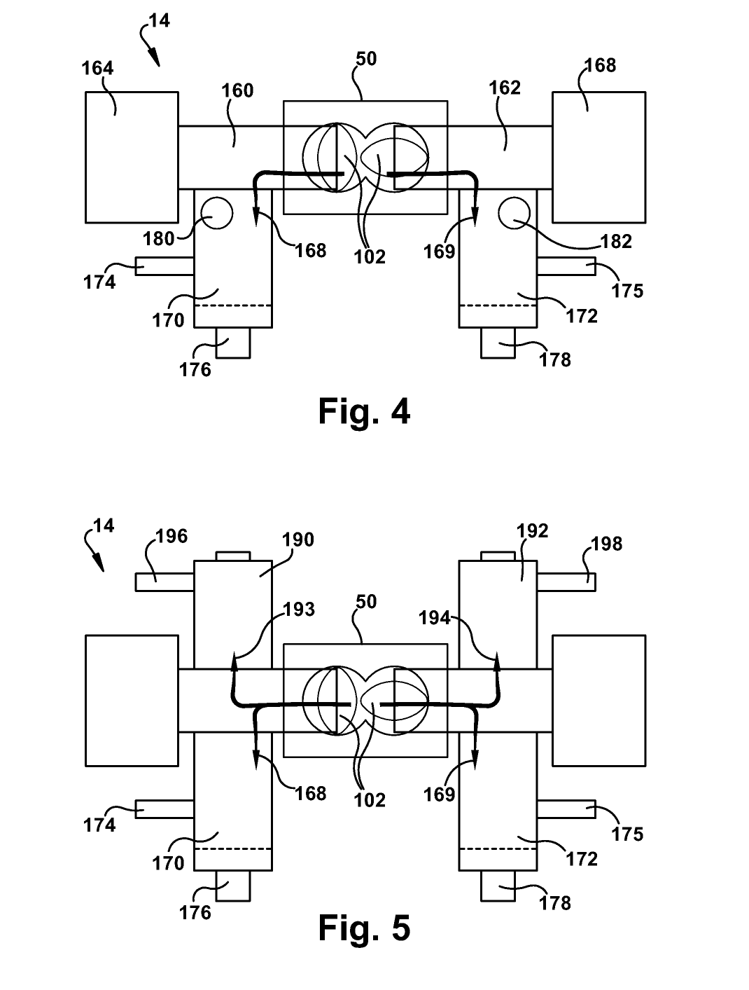

FIGS. 4 and 5 shows the end view of the extrusion apparatus 14 having two side feeder extruder. FIG. 4 is an end view of the extrusion apparatus 14 showing side feeders 160 and 162 according to an embodiment of the present invention. Side feeders 160 and 162 include a motor 164 and 166 which caused the screw elements 142, 144 (FIG. 2) to turn and direct any deposited polymer back into extruder hollow member 50 so that the polymer can be conveyed downstream by twin screw 102.

As shown and indicated by arrows 168, 169, the solvent as being driven downward towards vent and into vent boxes 170 and 172 which are mounted below the side feeders 160, 162. The side feeders can optionally be equipped with liquid overflow lines 174 and 175 and any polymer that is entrained in the solvent is collected in liquid form and into the liquid and polymer drains 176 and 178. The vent boxes 170, 172 can also optionally include vapor lines 180 and 182 which each may be equipped with a sight glass.

In another embodiment of the present invention the extruder apparatus 14 can include side feeders 160 and 162 as described above with accompanying vent boxes 170 and 172. In addition, side feeders 160 and 162 can also further include an additional vent box 190 and 192 that are mounted above side feeders 160 and 162. Vent boxes 190 and 192 collect solvent-vapor that is pulled upward in the direction indicated by arrows 193 and 194 and exits the solvent vapor lines 196 and 198.

The side feeders 160, 162, according to one embodiment, is relatively shorter in length compared to hollow member 50, for example, and has a length to diameter ratio (L/D) of about 20 or less, in another embodiment about 12 or less. The side feeder is preferably heated and functions to provide additional cross sectional area within the feed zone of the extruder thereby allowing higher throughput of the solvent-polymer mixture. The screw of the side feeders may be a single-screw or the twin-screw, for example.

As mentioned, the side feeder screws have conveying elements which serve to transport deposited polymer into the extruder. Side feeders comprising surface renewal screw elements are especially useful in instances in which the evaporating solvent has a tendency to entrain polymer particles in a direction opposite that provided by the conveying action of the side feeder screw elements and out through the vent of the side feeder. The extruder can be similarly equipped with surface renewal screw elements between the point of introduction of the polymer-solvent mixture and one or more of the upstream vents. As in the side feeder, the surface renewal extruder screw elements act as mechanical filters to intercept polymer particles being entrained by the solvent vapor moving toward the vents.

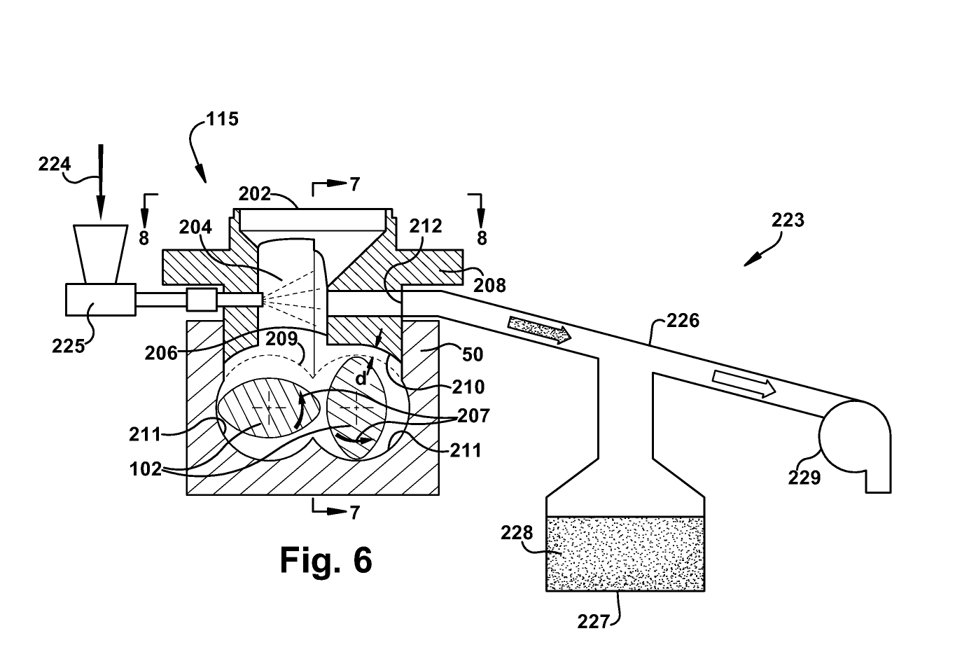

As mentioned above, the extrusion apparatus 14 can further include at least one vent insert, for example back flash vent insert 83, forward flash vent insert 115, and trace devolitilization vent inserts 117, 119, 121 and 123 (FIG. 3) according to the embodiment of the present invention. FIG. 6 is a transverse cross-section of extruder apparatus 14 showing vent insert 115 which is disposed at forward flash vent port 56 (FIG. 3) to control the flow of solvent and/or polymer which flows out of forward flash vent port 56, according to an example embodiment. Vent insert 115 includes a mouth 202 and a channel opening 204 which extends from the mouth 202 to inside the hollow member 50. The body 208 of the vent insert 115 has a shroud surface 210 to deflect polymer which may be pushed out of the hollow member 50 through its opening, i.e. forward flash vent port 56. Shroud surface 210 resides above the screw, for example twin-screw 102 and is positioned adjacent to inside surface 211 of hollow member 50. Screw 102 as shown, rotates counter-clockwise and as indicated by arrows 207 along the inside surface 211 of hollow member 50 and along vent port 68 along path indicated by dashed line 209. Screw 102 when rotating counter-clockwise has upturns near the center of the hollow member 50 and also adjacent inside surface 211. In an embodiment of the invention as shown, the shroud surface 210 is positioned adjacent to inside surface 211 at a position where screw 102 traverses forward flash vent port 56 on a screw “upturn”. In this arrangement, the shroud surface 210 partially closes the forward flash vent port 56 to deflect polymer, and particular a higher concentration of polymer that escapes with the solvent due to the upturn or counterclockwise motion of the screw. In an alternative embodiment, where the screw 102 rotates in a clockwise position, the vent insert 115 would be in a position, rotated 180 degrees, such that the shroud surface 210 would be positioned on the opposite side of hollow member 50 and adjacent the inside surface 211 at a position where screw 102 traverses forward flash vent port 56 again on a screw “upturn”.

In another embodiment, the shroud surface 210 can be shaped to substantially conform to the shape, i.e. is substantially similar, to the shape of the inside surface 211 of hollow member 50. There is a clearance indicated by distance, d, between a portion of the twin screw 102 and also shroud surface 210 of the vent insert. In this manner polymer which is pulled out of the hollow member is forced against shroud surface 210 which causes polymer to be deflected toward the inside of the hollow member 50. Vent insert 115 is dimensioned to impart a reduced clearance, d, between the screw 102 and the shroud surface 210. The vent insert clearance, d, can range from greater than zero to about 5 centimeters, in another embodiment from greater than zero to about 10 millimeters and in another embodiment from about 0.1 millimeter to about 1 millimeter. Each vent downstream of the feed inlet should have an opening, for example opening 204 of vent insert 115, that is sufficient to allow solvent to exit the hollow member during operation of the extruder while maintaining polymer in the hollow member. In one embodiment, pursuant to FIG. 6, the vent insert 115 comprises a shroud surface that is positioned a distance from the screw, the distance ranging from greater than zero to about 0.2 times the diameter of the hollow member.

FIG. 6 also illustrates an optional vent port cleaning device 223 disposed on the vent ports, for example forward flash vent port 58, which provides a method for reducing the likelihood of a shut down when polymer enters the vent ports. The isolation of polymer from solution using extruder sometimes causes the removal of low molecular weight species contained in the polymer, such as monomers, stabilizers, etc. that can escape the extruder through the extruder vents during processing. In some cases species can accumulate in the vent port of the extruder over some period of time until they can either fall back into the melt thus contaminating the final product or they can reduce the cross-sectional area of the vent and cause it to be plugged. The vent port cleaning devices uses solvent of high temperature to periodically wash off any contaminant that may accumulate in either the extruder vents or vapor collection lines over time thus minimizing operational difficulties that may lead to product contamination or extruder shut down. As shown, a superheated solvent can be fed, as indicated by arrow 224, to a high pressure injection nozzle 225 that injects the solvent into the vent insert 115. The vapor which contains the residuals then exits the vent insert through vapor line 227. As the vapor cools the residuals or contaminants can solidify and fall into the knock-out port 228 as the vapor is routed through a vacuum pump 229.

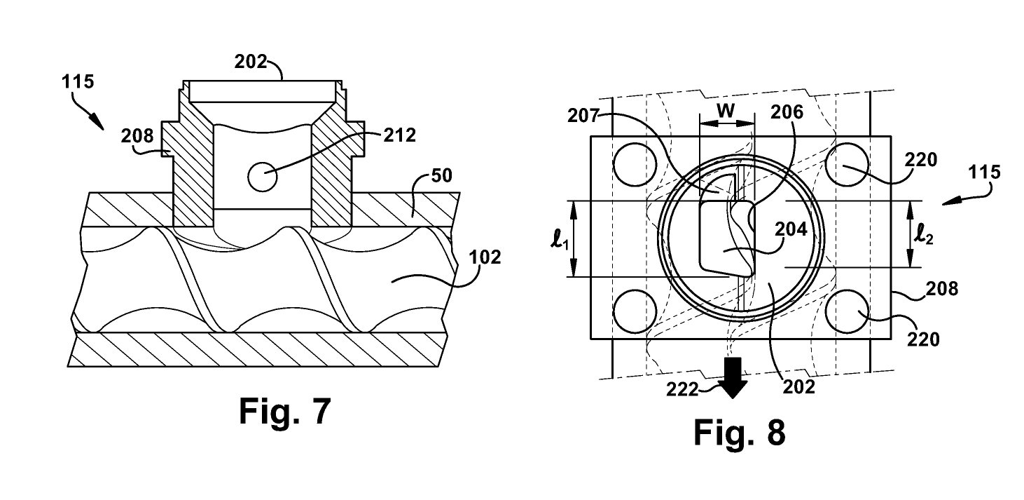

FIG. 7 is a longitudinal cross sectional view of vent insert 115 which resides in vent opening of hollow member 50 according to embodiment of the present invention. Vapors are moved from side view hollow member 50 and through opening 212 to the vapor line 227 (FIG. 6) and also out of the mouth 202 of the vent insert.

FIG. 8 is a cross sectional top view taken along lines 8-8 of FIG. 6 showing the opening inside channel 204 through the mouth 202 of the vent insert 115. Vent insert 115 can be mounted onto the hallow member 50 of extruder apparatus 14 via flange 208 which optionally includes openings 220 for mounting the vent insert securely to the hollow member 50. A cross-section of channel 204 shows an opening having a width, W, and sides which have two different lengths, I₁ and I₂. The channel, 204, of the vent insert is located in the direction of the screw that is opposite to the screw shourded by the insert. Further, the insert opening is dimension to provide a surface area sufficient to allow the removal of solvent from the polymer-solvent mixture and at the same time presenting the polymer from escaping from the extruder. The length of the opening 11 can range from about 0.6 time the diameter, 0.6D, of the hollow member 50 to about 0.9 times the diameter, 0.9D, of the hollow member; the length of the opening 12 can range from about 0.7 times the diameter, 0.7D, of the hollow member 50 to about 1.0 times the diameter, 1.0D, of the hollow member, and the width, W, can range from about 0.5 times the diameter, 0.5D, to about 0.8 times the diameter, 0.8D, of the hollow member. In another embodiment, length of the opening I₁ can range from about 0.7 time the diameter, 0.7D, of the hollow member 50 to about 0.8 times the diameter, 0.8D, of the hollow member; the length of the opening I₂ can range from about 0.8 times the diameter, 0.8D, of the hollow member 50 to about 1.0 times the diameter, 0.9D, of the hollow member, and the width, W, can range from about 0.6 times the diameter, 0.6D, to about 0.7 times the diameter, 0.7D. of the hollow member. The vent insert can further includes a wedge 207 which is a hollowed out section adjacent the channel opening 204 and which catches material coming out of the extruder. The wedge 207 can cause polymer to aggregate or ball up and then fall back into the hollow member 50.

In another embodiment, the system for separating polymer from a solvent comprising an extruder apparatus, the extruder apparatus comprising: a feed delivery system and a feed port; a hollow member having a first end portion and a second end portion, the hollow member having a diameter D. The extruder apparatus further includes at least one screw extending from the first end portion to the second end portion of the hollow member, wherein the hollow member contains at least one open section and at least one closed section and the hollow member is mechanically connected to the feed delivery system. The extrusion apparatus further includes at least one vent insert located on at least one open section of the hollow member, wherein the at least one vent insert is dimensioned to (i) impart a clearance between the at least one screw and the vent insert (ii) shroud a screw upturn, and the at least one vent insert has an at least one inner surface having a curvature that is substantially similar to the curvature of the hollow member, and wherein the at least one vent insert has at least one opening that is sufficient to allow solvent to exit the hollow member during operation of the extruder while maintaining polymer in the hollow member. The extruder apparatus further includes a an internal superheating section, having a length that is more than four times the diameter, 4D, of the hollow member located between the flash valve and at least one open section, and a downstream section, located between (i) an open section that separates the internal superheating section and (ii) the second end portion of the hollow member. In another embodiment the extruder apparatus optionally includes a close coupled flash valve mounted on the feed port of the extruder apparatus and a purge delivery system located at an open section of the hollow member, wherein the hollow member has an opening for receiving purging material from the purge delivery system.

In another embodiment of the present invention a method for separating a polymer from a solvent to isolate a polymer product, the method comprising: introducing a polymer-solvent mixture into feed port of an extruder apparatus which includes a screw disposed inside a hollow member, the hollow member comprising a feed port; a forward flash vent port downstream of the feed port and a back flash vent port upstream of the vent port; passing the polymer-solvent mixture through an internal superheating section of the extruder apparatus which is downstream of the feed port and is at least about four times the diameter, 4D, of the hollow member; and wherein the extruder apparatus is operated at a devolatilization performance ratio (DPR) which ranges from about 0.01 to about 200 to correlate with at least one target characteristic of the polymer product. The devolatilization performance ratio is the feed rate (FR) divided by the screw speed (RPM) according to Equation (I):

DPR=FR/RPM Equation (I)

According to another embodiment, the polymer-solvent mixture is first heated under pressure to produce a superheated polymer-solvent mixture, wherein the temperature of the superheated mixture is greater than the boiling point of the solvent at atmospheric pressure. Typically, the temperature of the superheated polymer-solvent mixture will range from greater than zero to about 200° C. higher than the boiling point of the solvent at atmospheric pressure, and in another embodiment from greater than about 2° C. to about 200° C. higher than the boiling point of the solvent at atmospheric pressure. Within this range, a temperature of less than or equal to about 150° C. can be employed, with less than or equal to about 100° C. preferred. Also preferred within this range is a temperature of greater than or equal to about 10° C., with greater than or equal to about 50° C. more preferred. More specifically, the temperature of the superheated polymer-solvent mixture prior to introduction into the extruder can be about 15 to about 100 percent greater than the boiling point of the solvent at the pressure where flash devolatilization occurs in the extruder, specifically about 25 to about 85 percent greater, and yet more specifically about 45 to about 70 percent greater.

The pressure of the forward flash vent port and the back flash vent port can each range from about 700 millimeters of mercury (mm of Hg) to about 800 millimeters of mercury, in another embodiment, from about 740 mm of Hg to about 780 mm of Hg, and in another embodiment, the pressure at one or more of the vent ports can be about atmospheric pressure. In another embodiment, the pressure at the forward flash vent port and the back flash vent port are substantially equal.

In another embodiment, the method further comprises passing the polymer-solvent mixture through a trace devolatilization portion of the extruder apparatus described above and further comprising at least one surface renewal section of the screw downstream of the internal superheating section, and at least one trace devolatilization vent port which is downstream of the surface renewal section. The pressure of the at least one trace devolatilization vent port is less than the pressure of at least one of the forward flash vent port and the back flash vent port. In another embodiment the pressure of the at least one trace devolatilization vent port can range from about greater than zero to about 400 mm of Hg, and in another embodiment, the pressure of the at least one trace devolatilization vent port can range from about 5 mm of Hg to about 200 mm of Hg.

In instances where there are multiple solvents present, the polymer-solvent mixture is superheated with respect to at least one of the solvent components. Where the polymer-solvent mixture contains significant amounts of both high and low boiling solvents, it is sometimes advantageous to superheat the polymer-solvent mixture with respect to all solvents present (i.e., above the boiling point at atmospheric pressure of the highest boiling solvent). Superheating of the polymer-solvent mixture may be achieved by heating the mixture under pressure.

Superheating may be described as the temperature a condensable gas is above its boiling point at its current pressure. The degree of superheat, (P₁^{v}−Pₜ), to characterize superheating, may be defined as the difference between the equilibrium pressure of the solvent in the vapor phase (P₁^{v}) and the total pressure in the space of the extruder where the devolatilization process takes place (Pₜ) as a positive value. In another embodiment, the flash separation of the solvent from the polymer-solvent mixture may be accomplished by applying vacuum to the heated mixture so the surrounding pressure is lower than the vapor pressure of the solvent in the mixture. This method is also described herein as superheating as the degree of superheat (P₁^{v}−Pₜ) is a positive value. A polymer-solvent mixture that is kept at a temperature below the boiling point of the solvent at atmospheric pressure can be in a superheated state as long as the surrounding pressure is lower than the vapor pressure of the solvent at the temperature of the mixture.

In one embodiment, the extruder preferably has a set hollow member temperature greater than 190° C., preferably greater than or equal to about 200° C. In one embodiment the extruder comprises heated zones. In one embodiment, the heated zones of the extruder are operated at one or more temperatures of 190° C. to about 400° C. The expression wherein the extruder is operated at a temperature of 190° C. to about 400° C. refers to the heated zones of the extruder, it being understood that the extruder may comprise both heated and unheated zones. Within this embodiment, the temperature of the heated zones may be greater than or equal to about 200° C., preferably greater than or equal to about 250° C., and even more preferably greater than or equal to about 300° C.

When the polymer-solvent mixture is pressurized, the system or apparatus 10 as described above can include a pressure control valve or feed valve 30 downstream of the heat exchanger, if used, or downstream of the feed tank. The pressure control valve preferably has a cracking pressure higher than atmospheric pressure. The cracking pressure of the pressure control valve may be set electronically or manually and is typically maintained at from about 1 pounds per square inch (psi) (0.07 kgf/cm²) to about 350 psi (25 kgf/cm²) above atmospheric pressure. Within this range, a cracking pressure of less than or equal to about 100 psi (7.0 kgf/cm²) can be employed, with less than or equal to about 50 psi (3.5 kgf/cm²) above atmospheric pressure preferred. Also preferred within this range is a cracking pressure of greater than or equal to about 5 psi (0.35 kgfcm²), with greater than or equal to about 10 psi (0.7 kgf/cm²) above atmospheric pressure more preferred. The back pressure generated by the pressure control valve is typically controlled by increasing or decreasing the cross sectional area of the valve opening. Typically, the degree to which the valve is open is expressed as percent (%) open, meaning the cross sectional area of valve opening actually being used relative to the cross sectional area of the valve when fully opened. The pressure control valve prevents evaporation of the solvent as it is heated above its boiling point. Typically, the pressure control valve is attached (plumbed) directly to an extruder and serves as the feed inlet of the extruder. A suitable pressure control valve includes a RESEARCH® Control Valve, manufactured by BadgerMeter, Inc., a valve manuctured by Schuf Inc.

In general, as the feed rate of the polymer-solvent mixture is increased a corresponding increase in the screw speed must be made in order to accommodate the additional material being fed to the extruder. Moreover, the screw speed determines the residence time of whatever material is being fed to the extruder, here a polymer-solvent mixture. Thus, the screw speed and feed rate are typically interdependent. It is useful to characterize this relationship between feed rate and screw speed as a ratio. Typically the extruder is operated such that the ratio of starting material introduced into the extruder in kilograms per hour on a solvent free basis (kg/hr) to the screw speed expressed in revolutions per minute (rpm) falls about 0.0045 to about 45, preferably about 0.01 to about 0.45. For example, the ratio of feed rate to screw speed where the polymer-solvent mixture is being introduced into the extruder at 400 kilograms per hour polymer on a solvent free basis into an extruder being operated at 400 rpm is 1. The maximum and minimum feed rates and extruder screw speeds are determined by, among other factors, the size of the extruder, the general rule being the larger the extruder the higher the maximum and minimum feed rates. In one embodiment the extruder operation is characterized by a ratio of a feed rate in kilograms per hour to an extruder screw speed in revolutions per minute, the ratio being between about 0.0045 and about 45. In an alternate embodiment the extruder operation is characterized by a ratio of a feed rate in pounds per hour to an extruder screw speed in revolutions per minute, the ratio being between about 0.01 and about 100.

Polymer-solvent mixtures comprising less than about 30 percent by weight solvent are at times too viscous to be pumped through a heat exchanger, one of the preferred methods for superheating the polymer-solvent mixtures. In such instances it is possible to superheat the polymer-solvent mixture by other means, for example, heating the polymer-solvent mixture in a extruder, or a helicone mixer, or the like. The polymer-solvent mixture may be superheated by means of a first extruder. The superheated polymer-solvent mixture emerging from the first extruder may be transferred through a pressure control valve into a second devolatilizing extruder equipped according to the method with at least one vent operated at subatmospheric pressure, optionally one or more vents operated at about atmospheric pressure, and at least one side feeder equipped with at least one vent being operated at atmospheric pressure. In one embodiment, the die face of the first extruder may serve as the pressure control valve, which regulates the flow of superheated polymer-solvent mixture into the second devolatilizing extruder. In this embodiment the superheated polymer-solvent mixture is introduced directly from the die face of the first extruder into the feed zone of the second devolatilizing extruder. The first extruder may be any single-screw extruder or twin-screw extruder capable of superheating the polymer-solvent mixture.

The polymer product emerges from the extruder as an extrudate, which may be pelletized and dried before further use. In some instances the polymer product, notwithstanding the action of the upstream, downstream, and/or side feeder vents present, may contain an amount of residual solvent which is in excess of a maximum allowable amount which renders the polymer unsuitable for immediate use in a particular application, for example a molding application requiring that the amount of residual solvent be less than about 100 parts per million based on the weight of the polymer product. In such instances it is possible to further reduce the level of residual solvent by subjecting the polymer product to an additional extrusion step. Thus, the extruder into which the polymer-solvent mixture is first introduced may be coupled to a second extruder, the second extruder being equipped with one or more subatmospheric or atmospheric vents for the removal of residual solvent. The second extruder may be closely coupled to the initial extruder thereby avoiding any intermediate isolation and re-melting steps. The use of a second extruder in this manner is especially beneficial during operation at high throughput rates where the residence time of the polymer in the initial extruder is insufficient to achieve the desired low level of residual solvent. The second extruder may be any vented extruder such as a vented twin-screw counter-rotating extruder, a vented twin-screw co-rotating extruder, a vented single-screw extruder, or a vented single-screw reciprocating extruder. The term vented extruder means an extruder possessing at least one vent, the vent being operated at atmospheric pressure or subatmospheric pressure. Where the extruder comprises a plurality of vents, some vents may be operated at atmospheric pressure while others are operated at subatmospheric pressure.

The application of the method to a polymer-solvent mixture effects the separation of the solvent component from the polymeric component. The polymeric component emerging from the extruder is said to be devolatilized and is frequently referred to as the polymer product. In one embodiment, the polymer product is found to be substantially free of solvent. By substantially free it is meant that the polymer product contains less than 5000 parts per million (ppm) residual solvent based on the weight of the sample tested. In some instances the amount of residual solvent in the polymer product isolated may exceed 5000 ppm. The concentration of solvent in the final product correlates with the ratio between the feed rate and the extruder screw speed, with lower ratios (that is lower rates, or higher screw speeds, or both) leading to lower concentrations of solvent in the polymer product. The concentration of the solvent in the polymer product may be adjusted by adjusting the feed rate and/or the extruder screw speed.

In one embodiment, the method provides a polymer product which is substantially free of solvent and is a polyetherimide having structure I. In an alternate embodiment, the method provides a polymer blend, which is substantially free of solvent. Examples of polymer product blends which are substantially free of solvent include blends containing at least two different polymers selected from the group consisting of polycarbonates, polyetherimides, polysulfones, poly(alkenyl aromatic)s, and poly(arylene ether)s.

The polymer-solvent mixtures separated by the method may comprise one or more solvents. These solvents include halogenated aromatic solvents, halogenated aliphatic solvents, non-halogenated aromatic solvents, non-halogenated aliphatic solvents, and mixtures thereof. Halogenated aromatic solvents are illustrated by ortho-dichlorobenzene (ODCB), chlorobenzene and the like. Non-halogenated aromatic solvents are illustrated by toluene, xylene, anisole, 1,2-dimethoxybenzene (veratrole), and the like. Halogenated aliphatic solvents are illustrated by methylene chloride; chloroform; 1,2-dichloroethane; and the like. Non-halogenated aliphatic solvents are illustrated by ethanol, acetone, ethyl acetate, and the like. Mixtures of the foregoing solvents are also contemplated (e.g. ODCB and veratrole).

As described previously, the polymer-solvent mixture can be superheated under pressure with the aid of a heat exchanger. The mixture is kept under pressure using a pressure-controlled valve and fed to the extruder through an inlet port located immediately downstream of the pressure valve. The mixture fed to the extruder is super-heated with respect to the conditions existing inside the extruder section where the back flash occurs. If the flash occurs at atmospheric pressure, the mixture is super-heated to a temperature that is above the normal boiling point of the solvent. If the flash occurs at sub-atmospheric pressure, the mixture temperature needs to be higher than the boiling point of the solvent at that pressure.

This method allows for the separation of a polymer from a relatively dilute solution of the polymer in a solvent to eliminate up to about 99.9% of the solvent contained in the solution fed to the extruder. This devolatilization process uses no vacuum to remove solvent from the melt (trace devolatilization), with all of the vents on the extruder operated at atmospheric pressure. The temperature of the super-heated polymer-solvent mixture controls, in part, the amount of solvent flashed and removed by the upstream vent (back flash); and further control the final amount of residual solvent in the melt exiting the extruder, with higher temperatures leading to lower concentrations of solvent in the final product. Likewise, the temperature of the melt exiting the surface renewal section between the feed inlet and the downstream vent controls, in part, the amount of solvent flashed or removed by the downstream vent (forward flash), with higher temperatures leading to lower concentration of solvent in the final product.

The higher the feed temperature is, the larger the percentage of solvent is removed by the upstream vent as opposed to the downstream vent. The ratio of solvent removal between the upstream vent (back flash) and the downstream vent (forward flash) can be about 70-90:10-30, specifically about 80-90:10-20, and yet more specifically about 85-90:5-15. There are advantages in terms of efficiency associated with maximizing the amount of solvent removed in the (atmospheric) flash devolatilization section of the process, thus minimizing the amount of solvent eliminated in the (vacuum) trace devolatilization section of the process for a given devolatilization task. The higher temperatures also lead to higher polymer rates through the extruder for the same final solvent concentration.

In another embodiment additional precautions may be taken to exclude oxygen from the extruder and from contact with the hot polymer as it emerges from the extruder dieface. Such precautions may assist in preventing discoloration of the polymer product, especially when the polymer product is known to darken or otherwise degrade at high temperature in the presence of oxygen. For example, polyetherimides and poly(phenylene ethers) are known to be sensitive to oxygen at high temperature and darken measurably when heated in the presence of oxygen. Steps which may be taken in order to minimize the concentration of oxygen in the extruder, or to minimize the exposure of the hot polymer emerging from the extruder dieface to oxygen include: wrapping external parts of the extruder with cladding and supplying the cladding with a positive pressure of nitrogen, enclosing with a housing supplied with a positive pressure of inert gas those sections of the extruder subject to the entry of oxygen due to the action of vacuum the vents, enclosing the entire extruder in an enclosure supplied with a positive pressure of nitrogen, and the like. Additionally, steps may be taken to degas the polymer-solvent mixture prior to its introduction into the extruder. Degassing may be effected in a variety of ways, for example sparging the polymer-solvent mixture with an inert gas and thereafter maintaining a positive pressure of an inert gas in the vessel holding the polymer-solvent mixture.

### Polymer-Solvent Mix

The polymer-solvent mixture may comprise a wide variety of polymers. Exemplary polymers include polyetherimides, polycarbonates, polycarbonate esters, poly(arylene ether)s, polyamides, polyarylates, polyesters, polysulfones, polyetherketones, polyimides, olefin polymers, polysiloxanes, poly(alkenyl aromatic)s, and blends comprising at least one of the foregoing polymers. In instances where two or more polymers are present in the polymer-solvent mixture, the polymer product may be a polymer blend, such as a blend of a polyetherimide and a poly(arylene ether). Other blends may include a polyetherimide and a polycarbonate ester. It has been found that the pre-dispersal or pre-dissolution of two or more polymers within the polymer-solvent mixture allows for the efficient and uniform distribution of the polymers in the resulting isolated polymer product matrix. As used herein, the term polymer includes both high molecular weight polymers, for example bisphenol A polycarbonate having a number average molecular weight Mₙ of 10,000 atomic mass units (amu) or more, and relatively low molecular weight oligomeric materials, for example bisphenol A polycarbonate having a number average molecular weight of about 800 amu. Typically, the polymer-solvent mixture is a product mixture obtained after a polymerization reaction, or polymer derivatization reaction, conducted in a solvent. For example, the polymer-solvent mixture may be the product of the condensation polymerization of bisphenol A dianhydride (BPADA) with m-phenylenediamine in the presence of phthalic anhydride chainstopper in ODCB, or the polymerization of a bisphenol, such as bisphenol A, with phosgene conducted in a solvent such as methylene chloride. In the first instance, a water soluble catalyst is typically employed in the condensation reaction of BPADA with m-phenylenediamine and phthalic anhydride, and this catalyst can removed prior to any polymer isolation step. Thus, the product polyetherimide solution in ODCB is washed with water and the aqueous phase is separated to provide a water washed solution of polyetherimide in ODCB. In such an instance, the water washed solution of polyetherimide in ODCB may serve as the polymer-solvent mixture which is separated into polymeric and solvent components using the method described herein. Similarly, in the preparation of bisphenol A polycarbonate by reaction of bisphenol A with phosgene in a methylene chloride-water mixture in the presence of an inorganic acid acceptor such as sodium hydroxide, the reaction mixture upon completion of the polymerization is a two-phase mixture of polycarbonate in methylene chloride and brine. The brine layer is separated and the methylene chloride layer is washed with acid and pure water. The organic layer is then separated from the water layer to provide a water washed solution of bisphenol A polycarbonate in methylene chloride. Here again, the water washed solution of bisphenol A polycarbonate in methylene chloride may serve as the polymer-solvent mixture which is separated into polymeric and solvent components using the method described herein.

Polymer derivatization reactions carried out in solution are frequently employed by chemists wishing to alter the properties of a particular polymeric material. For example, polycarbonate prepared by the melt polymerization of a bisphenol such as bisphenol A with a diaryl carbonate such as diphenyl carbonate may have a significant number of chain terminating hydroxyl groups. It is frequently desirable to convert such hydroxyl groups into other functional groups such as esters by reacting the polycarbonate in solution with an electrophilic reagent such as an acid chloride, for example benzoyl chloride. Here, the polymer is dissolved in a solvent, the reaction with benzoyl chloride and an acid acceptor such as sodium hydroxide is performed and the reaction mixture is then washed to remove water soluble reagents and byproducts to provide a polymer-solvent mixture necessitating solvent removal in order to isolate the derivatized polymer. Such polymer-solvent mixtures may be separated into polymeric and solvent components using the method described herein.

In one embodiment the polymer-solvent mixture comprises a polyetherimide having structure I

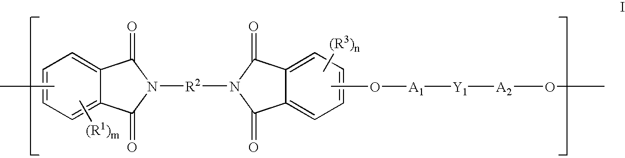

wherein R¹ and R³ are independently at each occurrence halogen, C₁-C₂₀ alkyl, C₆-C₂₀ aryl, C₇-C₂, aralkyl, or C₅-C₂₀ cycloalkyl;
R² is C₂-C₂₀ alkylene, C₄-C₂₀ arylene, C₅-C₂₀ aralkylene, or C₅-C₂₀ cycloalkylene;
A¹ and A² are each independently a monocyclic divalent aryl radical, Y¹ is a bridging radical in which one or two carbon atoms separate A¹ and A²; and m and n are independently integers from 0 to 3.

Polyetherimides having structure I include polymers prepared by condensation of bisphenol-A dianhydride (BPADA) with an aromatic diamine such as m-phenylene diamine, p-phenylene diamine, bis(4-aminophenyl)methane, bis(4-aminophenyl)ether, hexamethylenediamine; 1,4-cyclohexanediamine and the like.

The methods described herein are particularly well suited to the separation of polymer-solvent mixtures comprising one or more polyetherimides having structure I. Because the physical properties, such as color and impact strength, of polyetherimides I may be sensitive to impurities introduced during manufacture or handling, and because the effect of such impurities may be exacerbated during solvent removal, one aspect of the present method demonstrates its applicability to the isolation of polyetherimides prepared via distinctly different chemical processes.

One process for the preparation of polyetherimides having structure I is referred to as the nitro-displacement process. In the nitro displacement process, N-methylphthalimide is nitrated with 99% nitric acid to yield a mixture of N-methyl-4-nitrophthalimide (4-NPI) and N-methyl-3-nitrophthalimide (3-NPI). After purification, the mixture, containing approximately 95 parts of 4NPI and 5 parts of 3-NPI, is reacted in toluene with the disodium salt of bisphenol-A (BPA) in the presence of a phase transfer catalyst. This reaction gives BPA-bisimide and NaNO₂ in what is known as the nitro-displacement step. After purification, the BPA-bisimide is reacted with phthalic anhydride in an imide exchange reaction to afford BPA-dianhydride (BPADA), which in turn is reacted with meta-phenylene diamine (MPD) in ortho-dichlorobenzene in an imidization-polymerization step to afford the product polyetherimide.

An alternate chemical route to polyetherimides having structure I is a process referred to as the chloro-displacement process. The chloro displacement process is illustrated as follows: 4-chloro phthalic anhydride and meta-phenylene diamine are reacted in the presence of a catalytic amount of sodium phenyl phosphinate catalyst to produce the bischlorophthalimide of meta-phenylene diamine (CAS No. 148935-94-8). The bischolorophthalimide is then subjected to polymerization by chloro displacement reaction with the disodium salt of BPA in the presence of hexaethylguanidinium chloride catalyst in ortho-dichlorobenzene or anisole solvent. Alternatively, mixtures of 3-chloro- and 4-chlorophthalic anhydride may be employed to provide a mixture of isomeric bischlorophthalimides which may be polymerized by chloro displacement with BPA disodium salt as described above.

Polyetherimides prepared by nitro displacement or chloro displacement processes carried out on 4-NPI or bisphthalimide prepared from 4-chlorophthalic anhydride possess identical repeat unit structures, and materials of similar molecular weight should have essentially the same physical properties. A mixture of 3-NPI and 4-NPI ultimately affords, via the nitro displacement process, polyetherimide having the same physical properties as polyetherimide prepared in the chloro displacement process from a similarly constituted mixture of 3-chloro- and 4-chlorophthalic anhydride. Because the suite of impurities present in any polymer depends in part upon the method of its chemical synthesis, and because, as noted, the physical properties of polyetherimides are sensitive to the presence of impurities, a study was undertaken to determine whether the present method was applicable to the isolation of polyetherimides prepared by nitro displacement and chloro displacement without compromising the physical properties of either material. It has been found, and is well documented in the examples detailed herein, that the method may be applied to the isolation of both nitro displacement and chloro displacement polyetherimides without adversely affecting their physical properties. In some instances, as when the polymer contains insoluble particulate material, for example, dissolving the polymer in a solvent such as ODCB and filtering the solution to remove the insoluble particulate material followed by solvent removal according to the method allows recovery of polymer physical properties compromised by the presence of the insoluble particulate material. This effect of recovering polymer properties compromised by the presence of an impurity is observed in polyetherimides containing insoluble, dark particles (black specks) which are believed to act as stress concentrators during mechanical testing (e.g. Dynatup testing) and which negatively impact test scores.

Also contemplated herein are high glass transition temperature polyetherimides, for example those polyetherimides having a Tg of greater than about 225° C., specifically greater than about 235° C., and more specifically greater than about 245° C.

In one embodiment, the method may further comprise a compounding step. An additive, a filler, or an additional polymer may be added to the polymer-solvent mixture via the extruder which further comprises a non-venting side feeder. A non-venting side feeder differs from the side feeder mentioned previously in that the non-venting side feeder does not function to vent solvent vapors from the extruder. Such an embodiment is illustrated by the case in which an additive, such as a flame retardant or an additional polymer, is preferably introduced at a point along the extruder hollow member downstream of most or all vents that are present on the extruder hollow member for the removal of solvent. The additive so introduced is mixed by the action of the extruder screws with the partially or fully devolatilized polymer and the product emerges from the extruder die face as a compounded polymeric material. When preparing compounded polymeric materials in this manner it is at times advantageous to provide for additional extruder barrels and to adapt the screw elements of the extruder to provide vigorous mixing down stream of the point along the hollow member at which the additive is introduced. The extruder may comprise a vent downstream of the non-venting side feeder to remove volatiles still remaining, or that may have been produced by the side feeder addition of the additive, filler, and/or additional polymer to the extruder.

As mentioned above, the additional polymer introduced in the compounding step may include a polyetherimide, a polycarbonate, a polycarbonate ester, a poly(arylene ether), a polyamide, a polyarylate, a polyester, a polysulfone, a polyetherketone, a polyimide, an olefin polymer, a polysiloxane, a poly(alkenyl aromatic), and a combination comprising at least one of the foregoing polymers, and the like.

Non-limiting examples of fillers include silica powder, such as fused and fumed silicas and crystalline silica; talc; glass fibers; carbon black; conductive fillers; carbon nanotubes; nanoclays; organoclays; a combination comprising at least one of the foregoing fillers; and the like.

The amount of filler present in the polymer can range anywhere of about 0 to about 50 weight percent based on the total weight of the composition, preferably from about 0 to about 20 weight percent thereof.

The additives include, but are not limited to, colorants such as pigments or dyes, UV stabilizers, antioxidants, heat stabilizers, foaming agents, and mold release agents. Where the additive is one or more conventional additives, the product may comprise about 0.0001 to about 10 weight percent of the desired additives, preferably about 0.00001 to about 1 weight percent of the desired additives.

In another embodiment, the polymer-solvent mixture may further comprise at least one filler and/or at least one additive prior to its introduction into the extruder. It has been found that the pre-dispersal of filler into the polymer-solvent mixture allows for the efficient and uniform distribution of the filler in the resulting isolated polymer product matrix. The lower viscosity of the polymer-solvent mixture allows for efficient mixing of the filler and polymer with a minimized usage of energy as compared to compounding the filler and polymer in an extruder or similar device. Accordingly, a one-step process of compounding/isolation/devolatilization is disclosed to provide filled polymer product without the need for the usual remelting and compounding of the polymer and filler after the isolation step has been performed. A further advantage of adding the filler to the polymer-solvent mixture rather than compounding it in an extruder is to minimize the heat history of the polymer.

In one embodiment, the polymer-solvent mixture further comprises a liquid crystalline polymer, such as liquid crystalline polyester and copolyesters. Suitable liquid crystalline polymers are described in U.S. Pat. Nos. 5,324,795; 4,161,470; and 4,664,972.

The fillers and additives that may be dispersed in the polymer-solvent mixture may be any of those listed for the additional compounding step above.

Polymeric materials isolated according to the methods described herein may be transformed into useful articles directly, or may be blended with one or more additional polymers or polymer additives and subjected to injection molding, compression molding, extrusion methods, solution casting methods, and like techniques to provide useful articles. Injection molding is frequently the more preferred method of forming the useful articles.

The following examples are set forth to provide those of ordinary skill in the art with a detailed description of how the methods claimed herein are carried out and evaluated, and are not intended to limit the scope of what the inventors regard as their invention.

### EXAMPLES 1 THROUGH 6

Equipment, Materials and Procedures:

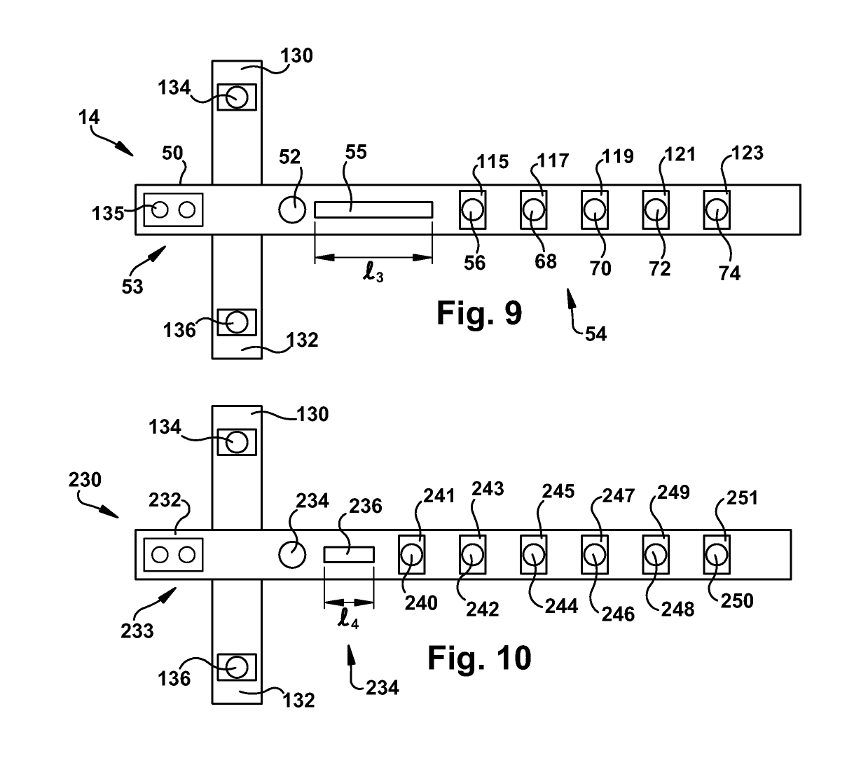

A laboratory scale extruder similar to the arrangement as shown in FIGS. 2 and 9 was used to separate an Ultem polymer from dilute solutions of the polymer in a solvent or a mixture of solvents. This process included a 25 mm-diameter, co-rotating intermeshing twin-screw extruder, that contained ten barrels (extruder length-to-diameter ratio equal to 40 The extruder apparatus included six vents, three of which were operated at atmospheric pressure or slight vacuum, and the remaining three vents were operated at different levels of vacuum. A heat exchanger, and pressure-controlled valve were used upstream of the extruder to produce a, super-heated Ultem/solvent solution that can be fed continuously to the extruder. The two screws used in the extruder include kneading blocks of different design, and a series of double-flighted, conveying screw elements to transport the melt forward and to also accommodate the solvent vapors produced by the devolatilization process. The feed solution is added to the extruder through an injection port located at the downstream edge of extruder barrel number two. The vent ports were located at barrels number one, two (on the side feeder/vent), four, five, seven and nine. Slight suction, generated by a Venturi tube at the exit of the condenser operated with the atmospheric vents, is used to facilitate the removal of solvent vapors from the upstream section of the extruder where most of the flash devolatilization occurs.

The three screw configurations, A, B, and C, studied differed mainly in the amount of mixing intensity provided by the screws in the two main sections of the process where internal superheating section (between the feed valve and the 1^{st} vent at atmospheric pressure) and trace devolatilization (surface renewal which was downstream of the melt seal, under vacuum) take place. Results of the process were carried out in three different extruder apparatus designs are listed in Table 1. The extruder barrel and solution feed temperatures in these experiments were kept constant, and at approximately 350° C. and 300° C., respectively. The solution feed rate in these experiments was 75 lb/hr, and the screw speed used was either 300 or 600 rpm.

10252005, Screw design A had six total vents, a mild internal superheating section upstream, two strong vacuum seals, and no kneading section for surface renewal downstream.

12092005, Screw Design B had more kneading capability in both the upstream and downstream sections of the extruder. In terms of devolatilization performance, a more aggressive upstream kneading section resulted in more viscous heat being introduced into the polymer-solvent mixture entering the forward devolatilization flash, whereas a more intense downstream kneading section generated more surface area renewal, both effects resulted in a more efficient performance of the isolation process in terms of residual solvent in the final extrudate. It should be pointed out, however, that the barrel configuration corresponding to the Screw Design B contained a total of only five vents (3 atm vents and two vacuum vents), a longer internal superheating section, and a shorter section for trace devolatilization.

2162006, Screw design C had more kneading capability in the downstream section of the extruder where devolatilization was driven primarily by the generation of surface area in the melt. Also, the dynamic viscous seal between the last atmospheric vent and first vacuum vent was strengthened with two tight-pitch, conveying elements to more efficiently separate the two sections of the process that operate at different pressures. Still another modification to the reference screw design was the incorporation of more open, conveying elements in the section of the screw that is located right under the feed port.

The residual o-DCB obtained using, 12092005 (screw Design B), was found to be higher than 10252005 (Screw Design A), owing to the barrel configuration corresponding to the 12092005 (screw Design B) design containing a total of only five vents (only two vacuum vents), only one left-handed seal, and a shorter section for trace devolatilization. Consequently, the full benefits of the increased surface renewal were not realized and lost in part due to the reduction in the number of vents leading to higher amounts of residual o-DCB in the polymer compared to 10252005 (screw design A). Further it was observed that the 1^{st} atmospheric vent located after the internal superheating section was more stable owing to the longer superheating section.

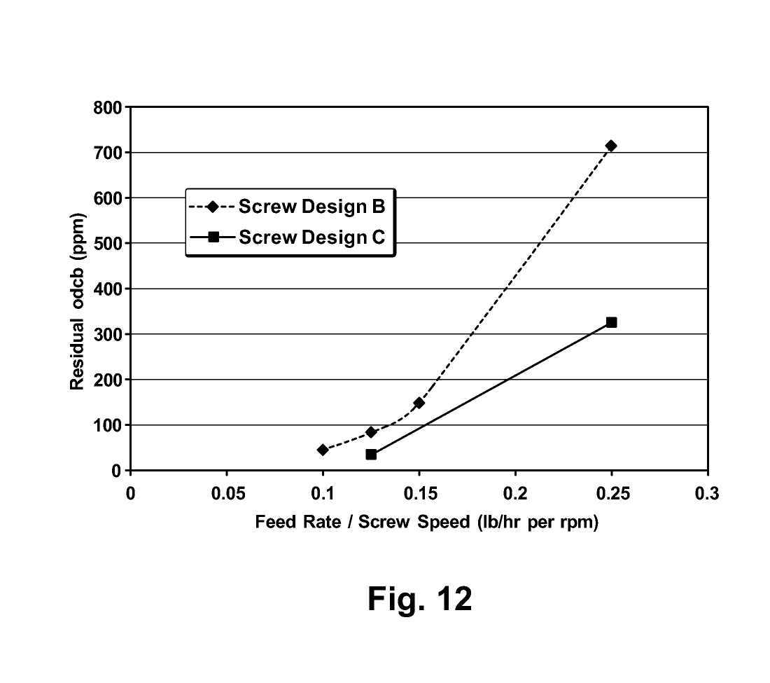

FIG. 12 is a plot of data found on Table I and shows that screw design 02162006 (Screw Design C) produced a better devolatilization performance in terms of residual solvent than the reference screw, at both low (good surface area renewal) and high (poor surface area renewal) ratios of the feed rate and screw speed. The numerical values of residual odcb for the three experiments described above, at both the low and high screw speeds investigated, are given in the Table 1 below. Further it was observed that the 1^{st} atmospheric vent located downstream of the internal superheating section was more stable owing to the longer superheating section. From examples 1-6, it was concluded that the combination of a longer internal superheating section with increased surface nenewal provided the best results—the 1^{st} atmospheric vent located after the internal superheating section was more stable and the residual levels were lower.

| | Example1 | Example2 | Example3 | Example4 | Example5 | Example 6 |
|---|---|---|---|---|---|---|
| | Screw | Screw | Screw | Screw | Screw | Screw |
| | Design B | Design A | Design C | Design B | Design A | Design C |
| Condition | 12092005-4 | 10252005-4 | 02162006-2 | 12092005-2 | 10252005-2 | 02162006-1 |
| Pressure at atm vents (mm Hg) | 744 | 738 | 751 | 744 | 738 | 751 |
| Pressure at vacuum vents (mm Hg) | ~1 | ~1 | ~1 | ~1 | ~1 | ~1 |
| Polymer Solution feed rate (lb/hr) | 75 | 75 | 75 | 75 | 75 | 75 |
| % polymer in the polymer solution | 30 | 30 | 30 | 30 | 30 | 30 |
| Die melt temperature (deg C.) | 402 | 401 | 401 | 421 | 422 | 416 |
| Screw Speed (rpm) | 300 | 300 | 300 | 600 | 600 | 600 |
| Actual barrel temperature (deg C.) | 350 | 350 | 350 | 350 | 350 | 350 |
| T feed tank (deg C.) | 165 | 146 | 162 | 164 | 146 | 162 |
| T feed (deg C.) | 301 | 302 | 300 | 298 | 300 | 298 |
| P feed (psi) | 144 | 146 | 139 | 152 | 139 | 143 |
| Number of atm vents | 3 | 3 | 3 | 3 | 3 | 3 |
| Number of vacuum vents | 2 | 3 | 2 | 2 | 3 | 2 |
| Length of kneading in back flash section | 72 | 36 | 72 | 72 | 36 | 72 |
| (KB mm) | | | | | | |
| Length of internal superheating section | 156 | 84 | 156 | 156 | 84 | 156 |
| (KB mm) | | | | | | |
| Length of surface renewal section | 40 | 24 | 84 | 40 | 24 | 84 |
| Length of section for trace | 424 (1 LH | 616 (2 LH | 468 (1 LH | 424 (1 LH | 616 (2 LH | 468 (1 LH |
| devolatilization (mm, DS of seal) | seal) | seal) | seal) | seal) | seal) | seal) |
| Length of screws occupied by kneading | 268/26.5 | 144/14.2 | 312/30.5 | 268/26.5 | 144/14.2 | 312/30.5 |
| blocks (%) | | | | | | |
| DPR (Feed rate/rpm) (lb/hr/rpm) | 0.075 | 0.075 | 0.075 | 0.0375 | 0.0375 | 0.0375 |
| Residual o_DCB (ppm) | 714 | 485 | 325 | 84 | 50 | 34 |

### EXAMPLES 7 THROUGH 10

Equipment, Materials and Procedure

In the following Examples and Comparative Example, the effect of design features of the extrusion apparatus on the polymer isolation process was evaluated in terms of heat balance of the process and also the residual solvent and retention of molecular weight in the final product.

In Examples 7-9 an extrusion apparatus of the arrangement shown in FIG. 9 was used and in Example 10 (Comparative) an extrusion apparatus of the design shown in FIG. 10 was used to carry out the polymer isolation process. In all of the Examples described herein, the polyetherimide of the polyetherimide-solvent solutions. is used with ULTEM® XH polyetherimide which is commercially available from SABIC Innovative Plastics, Mt Vernon, Ind.

The polymer isolation process of all Examples were carried out practicing the following procedure. A superheated polymer-solvent mixture was introduced into extruder apparatus 14, and the polymer product that resulted was isolated. The operating conditions of the extruder apparatus are summarized in Table 2 below. The extruder apparatus operated at a feed rate FR of −50-90 Kg/hr polymer and at a screw speed ranging from 175-200 RPM such that a devolatilization performance ratio (DPR) ranged from about 0.25 to about 0.5 (Kg/hr/rpm) to correlate with a target characteristic of the polymer product.

Predetermined target characteristics were a residual solvent level less than 500 ppm The feed tank 16 (FIG. 1) to the extruder apparatus 14 was maintained at a temperature of 150-180° C. The feed material contained a polymer-solvent mixture (polyetherimide in orthodichlorobenzene or orthodichlorobenzene+veratrole) at 30-35% polymer concentration. The extruder was fed using a pump through a heat exchanger 24 (FIG. 1). The feed at the exit of the heat exchanger was at a temperature ranging from 280-310° C. The superheated polymer-solvent mixture was kept at a pressure of 150-200 psi and was controlled using the feed valve. The pressures at which the sub-atmospheric vents were operated at are specifically listed below if Table 2. The barrels 1-6 were set at 370 C, while barrels 6-14 were set at 350 C. The pellets were collected at the end of the extruder and analyzed for residual solvent level. The yield of the polymer pellets exiting the extruder was measured and defined as follows: Yield (%)=100*(weight of polymer pellets exiting the extruder/weight of polymer in the polymer solution fed to the extruder on a solvent free basis).

### EXAMPLE 7

The polymer isolation process of Example 7 was carried out using an extrusion apparatus as shown in FIG. 9. The extrusion apparatus 14 included a hollow member 50 having a feed port, an upstream portion 53 and a downstream portion 54. The hollow member 50 contained a co-rotating, intermeshing (i.e. self wiping) twin-screws screws having a diameter, D, 58 millimeters and extending from the upstream portion 53 to the downstream portion 54. The internal superheating section 55 was disposed between the feed port 52 and the forward flash vent opening 56. The hollow member had eight (8) vent openings, five downstream vent openings 56, 68, 70, 72 and three upstream vent openings 134, 135, and 136. Four vent openings including the three upstream vent openings 134, 135 and 136 and one downstream vent opening 56, were operated at about atmospheric pressure and the remaining four downstream vent openings 68, 70, 72 and 74 were operated at sub-atmospheric pressure. Vent inserts 115, 117 were of the type shown in FIGS. 6-8. Vent inserts were used in all the downstream vents 56, 68, 70, 72 and 74 and each had an opening that was sufficient to allow solvent to exit the hollow member during operation of the extruder while maintaining polymer in the hollow member. A heated closely-coupled flash valve was mounted onto feed port 52 and had the capability to purge polymer-solvent mixture through the feed port 52.

### EXAMPLE 8

The process of Example 7 was repeated except that the process was run under different conditions described below in Table 2.

### EXAMPLE 9

The process of Example 7 was repeated except that the process was run under different conditions described below in Table 2.

### EXAMPLE 10

### Comparative

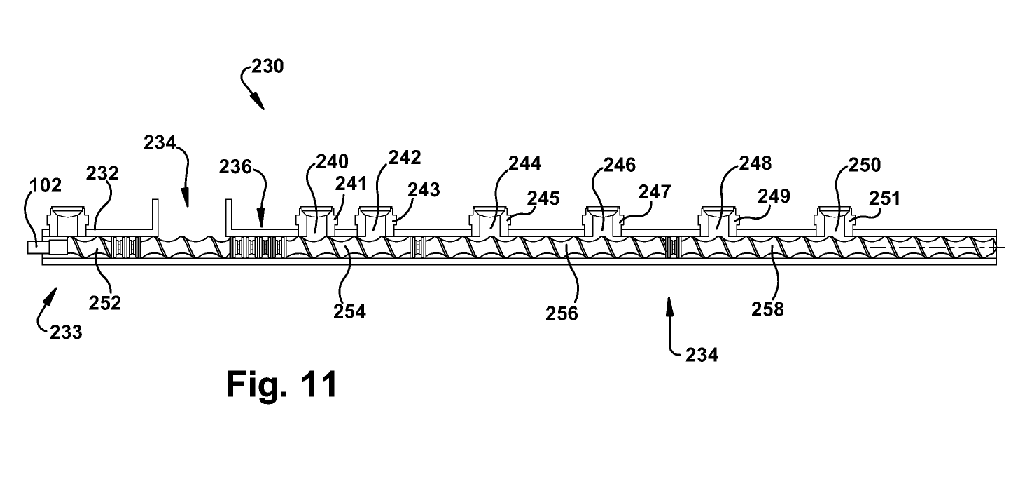

The polymer isolation process of Example 10 (Comparative) was carried out using an extrusion apparatus as shown in FIGS. 10 and 11. Other than changes in the extrusion apparatus, the polymer isolation process as described above with respect to Examples 1-3 was repeated with the specific conditions listed below in Table 2. A comparison between the extrusion apparatus schematics shown in FIGS. 9 and 10 illustrate that Example 10 (Comparative) had a relatively shorter internal superheating section, an additional vent and had fewer surface renewal elements.

FIGS. 10 and 11 show extrusion apparatus 230 included a hollow member 50 having a feed port 52, an upstream portion 53 and a downstream portion 54. The hollow member 50 contained a co-rotating, intermeshing (i.e. self wiping) twin-screws screws having a diameter, D, 58 millimeters and extending from the upstream portion 53 to the downstream portion 54. The superheating section 232 was disposed between the feed port 52 and the forward flash vent port 240. The hollow member had nine (9) vent openings, six downstream vent openings 240, 242, 244, 246, 248, and 250, and three upstream vent openings 134, 135, and 136. The pressure at four (4) vent openings including the three upstream vent openings 134, 135 and 136 and one downstream vent opening 240, were operated at approximately atmospheric pressure, the pressure at two (2) vents operated at sub atmospheric pressure and the remaining four downstream vent openings 68, 70, 72 and 74 were operated at approximately sub-atmospheric pressure. 4 vents operate at ˜atm pressure. One of these vents was a back vent, two were side vents and one was a forward vent. 2 vents operated between 10-200 millimeters of mercury (mm of Hg) (med vac vents) and 3 vents operated between 10-30 millimeters of mercury (mm of Hg) (high vac vents). Vent inserts 241, 243, 245, (not shown) were different than the type used for Examples 1-3 and were standard products supplied by the manufacturer. A heated closely-coupled flash valve was mounted onto feed port 52 and had the capability to purge polymer-solvent mixture through the feed port 52.

TABLE II
Comparison of Hardware

| | Example 7, | |
|---|---|---|
| Configuration | 8, 9 | Example 10 |
| Number of atm vents | 4 | 4 |
| Number of med vac vents | 1 | 2 |
| Number of high vac vents | 3 | 3 |
| Lenghth of superheating section | 7D | 4D |
| Inserts in down stream atm and | New design | Standard |
| med vac | | design |
| vent | | |
| Valve purge capability | Yes | No |
| Downstream surface renewal | 7D | 1D |

TABLE III

| | Example 7 | Example 8 | Example 9 | Example 10 |
|---|---|---|---|---|
| Polymer-Solvent | Polyetherimide | Polyetherimide | Polyetherimide | Polyetherimide |
| Description | solution in o-DCB | solution in o-DCB | solution in o-DCB | solution in o-DCB |
| | and veratrole | and veratrole | and veratrole | |
| Feed composition | 30-35% polymer | 30-35% polymer | 30-35% polymer | 30-35% polymer |
| | in solvent | in solvent | in solvent | in solvent |
| Feed Rate (lb/hr) | 480 | 494 | 497 | 100-500 |
| soln | | | | |
| SCREW SPEED | 188 | 192 | 189 | 150-190 |
| (RPM) | | | | |
| Feed Temperature | 280-300 C. | 280-300 C. | 280-300 C. | 280-300 C. |
| Pressure at atm | 750 | 750 | 750 | 750 |
| vents (mm Hg | | | | |
| Med Vacuum | 50 | 72 | 43 | 52 |
| (mm Hg) | | | | |
| High Vacuum | | | | |
| (mm Hg) | 17 | 15 | 6 | 13 |

### Discussion

Extrusion operations were effected apparatus changes. Examples 7-9 had a screw design which included a longer internal reheating section, and increased number of surface renewal blocks in the downstream section. The effects these changes had on the devolatilization performance of the extrusion isolation process were evaluated in terms of residual solvent in the final product, retention of molecular weight, and heat balance of the process. In addition, a closely coupled heated and insulated flash valve was also used in Examples 7-9.

The results showed that the use of the configuration of Examples 7-9 produced results that had relatively high yields of more than 85% and a residue solvent level of less than 300 ppm. Further, the results showed that the configuration we used resulted in a melt temperature of less than 800 F (430 C). In Examples 7-9, the extrusion operation was run for >24 h continuously. The feed solution was fed at a concentration of about 30% and the feed rate was maintained between 450-500 lb/hr of solution, while the vacuum was maintained at an average value of 15 and 17 millimeters of mercury (mm of Hg) respectively. In all cases, yields of >85% were obtained and the melt temperature of the polymer exiting the die of the extruder was <800 F.

The results of Example 9 showed that the use of the configuration of our invention resulted in relatively high yields of more than 85% and a residue solvent level of less than 300 ppm (or 500). Further, the results showed that the configuration we used resulted in a melt temperature of less than 800 F (430 C). These are very commercially useful results. The results of Example 10 (Comparative) experienced equipment shutdowns and extremely poor results.

### EXAMPLE 11

### Equipment, Materials and Procedure

Examples 11 was carried out with the following apparatus. The apparatus had a feed delivery system having an opening for receiving feed. The apparatus included a hollow member having a first end and a second end and containing two screws extending from the first end to the second end. The hollow member, the extruder had several vents. Four of these vents were operated at sub atmospheric pressure and four were operated at about atmospheric pressure. The vent inserts were used in all the vents downstream of the feed. Each vent downstream of the feed had an insert had at opening that was sufficient to allow solvent to exit the hollow member during operation of the extruder while maintaining polymer in the hollow member. A close coupled flash valve which was heated and had the capability to purge through the valve was mounted on the opening for receiving feed. An internal superheating section was designed in the screws inside the barrel of the extruder between the flash valve and a section having at least one open section. A purge delivery system was located at a section of the hollow member. The purge delivery system had an opening for receiving purging material. The deed material was a polyetherimide solution.

Example 11 was carried out practicing the following procedure. A superheated polymer-solvent mixture was introduced into an extruder, and the polymer product that resulted was isolated. The extruder was equipped with at four vents that operated at subatmospheric pressure and four vents that operated at about atmospheric pressure. The extruder had two (a) screws with a diameter, D, 58 mm. The extruder operated at a feed rate FR of 50-80 Kg/hr solution and at a screw speed ranging from 175-200 RPM.

The feed tank to the extruder was maintained at a temperature of 150-180 C. The feed material contained a polymer-solvent mixture (polyetherimide in orthodichlorobenzene) at 30-35% polymer concentration. The extruder was fed using a pump through a superheater. The feed at the exit of the superheater was at a temperature ranging from 280-310 C. The superheated polymer-solvent mixture was kept at a pressure of 150-200 psi and was controlled using the feed valve. The extruder was fed at a rate of 200-230 kg/hr. The vacuum vents were operated at 10-30 millimeters of mercury (mm of Hg). The pellets were collected at the end of the extruder and analyzed for residual solvent level. The yield of the polymer exiting the extruder was measured.

Results: This example details the levels of various molecules present in the feed that are reduced as part of the polymer devolatilization process. The conditions for the experiment are shown in Table IV results of the experiment are shown in Table V.

Table IV: Conditions for Extrusion for Example 11

TABLE IV

| | Mass flow | | Medium | Medium | | | |
|---|---|---|---|---|---|---|---|
| | rate | | vac vent | vac vent | Melt | | |
| | (solution | Screw | pressure | pressure | temp | Barrel | Barrel |
| Material | lb/hr) | Speed | (mm HG) | (mm Hg) | (deg C.) | temp (1-5) | temp (6-14) |
| CDU | 870 | 350 | 53 | 10 | 423 | 371 | 343 |
| Experimental | | | | | | | |
| resin | | | | | | | |

Table V: Table V shows the data for polyetherimide with a low level of residuals

TABLE V

| Residual | ppm |
|---|---|
| BPA (Bisphenol) | 29 |
| o-DCB (Orthodichlorobenzene) | 337 |
| HEGCl (Hexaethylguanidium Chloride) | <5 |
| PEG (Pentaethylguanandinium) | <5 |
| 4,4′ ClPAMI (chlorophthalamide) | 245 |
| PAMI (phthalamide) | 125 |

The invention has been described in detail with particular reference to preferred embodiments thereof, but it will be understood by those skilled in the art that variations and modifications can be effected within the spirit and scope of the invention.

What is claimed is:

1. A system for separating polymer and solvent from a polymer-solvent feed, the system comprising:
an extrusion apparatus comprising:
a hollow member having a first end portion, a second end portion, and a feed port disposed between the first end portion and the second end portion;
a screw disposed inside the hollow member extending from the first end portion to the second end portion of the hollow member;
a back flash vent port disposed upstream of the feed port and a forward flash vent port disposed downstream of the feed port;
a vent insert disposed at the forward flash vent opening;
an internal superheating section disposed between the feed port and the forward flash vent port of the hollow member, the superheating section having a length that is greater than four times the diameter, 4D, of the hollow member.

2. The apparatus of claim 1, wherein the hollow member comprises a solid or segmented barrel.

3. The system of claim 1, wherein the screw is a single screw or a twin-screw extending from the first end portion to the second end portion of the hollow member.

4. The system of claim 1, further comprising a close coupled flash valve mounted on the feed port, wherein the close coupled flash valve can achieve a temperature that is at least as great as the temperature of the feed that is introduced into the delivery system.

5. The system of claim 4, wherein the close coupled flash valve is set to open at a predetermined pressure, which is determined from the vapor pressure of the solvent at the temperature of the solution fed to the extruder.

6. The system of claim 5, wherein the close coupled flash valve is at least one of mechanically and electronically controlled.

7. The system of claim 1, wherein a portion of the screw along the superheating section comprises kneading elements having a combined length which ranges from more than about four times the diameter of the diameter, 4D, to about twelve times the diameter, 12 D, of the hollow member.

8. The system of claim 7, wherein the kneading elements of the superheating section have combined length which ranges from 50% to 95% of the distance between the flash valve and the at least one open section.

9. The system of claim 1, wherein the system further comprises a purge delivery system located at the feed port and which discharges polymer to the extruder apparatus.

10. The system of claim 9, wherein the purge delivery system comprises a volumetric feeder which discharges the polymer at a predetermined rate.

11. The system of claim 9, wherein the purge delivery system comprises a tank, a pump, and a flash valve.

12. The system of claim 1, wherein the screw is a twin-screw, co-rotating intermeshing screw.

13. The system of claim 1, wherein the length of the hollow member ranges from about twenty times the diameter, 20 D, to about sixty times the diameter, 60 D, of the hollow member.

14. The system of claim 1, wherein the diameter of hollow member ranges from about ten 10 millimeters to about 400 millimeters.

15. The system of claim 1, wherein the extruder system further comprises a surface renewal section downstream of the forward flash vent port.

16. The system of claim 1, further comprising a trace devolatilization vent port downstream of the surface renewal section.

17. The system of claim 16, wherein the hollow member has a length, L, and the length of the surface renewal section ranges from about 1% to about 54% of the length of the hollow member.

18. The system of claim 1, wherein the hollow member has a length, L, and the length of the superheating section ranges from about 4% to about 25% of the length of the hollow member.

19. The system of claim 1, wherein the extruder apparatus comprises at least two downstream surface renewal sections.

20. The system of claim 19, wherein the extruder apparatus comprises a trace devolatilization vent port downstream of each of the at least two surface renewal sections.

21. The system of claim 19, wherein the combined length of at least one surface renewal sections ranges from about 0.5 times the diameter of the hollow member, D to about 30 times the diameter of the hollow, D, member.

22. The system of claim 1, wherein the length of at least one surface renewal section ranges from about 0.5% to about 6% of the overall length, L,

23. The system of claim 1, wherein the vent insert comprises a shroud surface adjacent to the hollow member in a direction which coincides with the rotation of the screw.

24. The system of claim 1, wherein the vent insert comprises a shroud surface that is positioned a distance from the screw, the distance ranging from greater than zero to about 0.2 times the diameter of the hollow member.

25. The system of claim 1, wherein the vent insert comprises a shroud surface which has a shape which is substantially similar to the shape of the hollow member.

26. The system of claim 19, wherein the combined length of the superheating section and the surface renewal sections ranges from about 4 times the diameter of the hollow member, D to about 14 times the diameter of the hollow member.

27. A method of separating a polymer from a solvent, said method comprising:
(a) introducing a superheated polymer-solvent mixture into an extruder of claim 1, and isolating a polymer product, said extruder being equipped with at least one vent operated at subatmospheric pressure and at least one vent operated at about atmospheric pressure, said extruder having a screw, the screw having a diameter, D, said extruder being operated at a feed rate FR and at a screw speed RPM such that a devolatilization performance ratio (DPR) given by Equation (I)
DPR=FR/RPM Equation (I)
is selected from a predetermined set of devolatilization performance ratios ranging from about 0.01 to about 200 and which correlate with a target characteristic of the polymer product;
wherein the extruder is an apparatus comprising:
a feed delivery system having an opening for receiving feed,
a hollow member having a first end portion and a second end portion, the hollow member having a diameter D; and
at least one screw extending from the first end portion to the second end portion of the hollow member, wherein the hollow member contains at least one open section and at least one closed section and the hollow member is mechanically connected to the feed delivery system;
at least one vent insert located on at least one open section of the hollow member, wherein the at least one vent insert is dimensioned to (i) impart a clearance between the at least one screw and the vent insert (ii) shroud a screw upturn, and the at least one vent insert has an at least one inner surface having a curvature that is substantially similar to the curvature of the hollow member, and wherein the at least one vent insert has at least one opening that is sufficient to allow solvent to exit the hollow member during operation of the extruder while maintaining polymer in the hollow member;
a close coupled flash valve mounted on the opening of the feed delivery system of the extruder apparatus;
an internal superheating section, having a length that is more than 4D, of the hollow member located between the flash valve and at least one open section;
a downstream section, located between (i) the open section that separates the internal superheating section and (ii) the second end portion of the hollow member; a purge delivery system located at an open section of the hollow member, wherein the hollow member has an opening for receiving purging material from the purge delivery system.

28. A method of a method for separating a polymer from a solvent to isolate a polymer product, the method comprising:
introducing a polymer-solvent mixture into feed port of an extruder apparatus wherein the extruder apparatus comprises a screw disposed inside a hollow member, the hollow member comprising a feed port; a forward flash vent port downstream of the feed port and a back flash vent port upstream of the vent port;
passing the polymer-solvent mixture through an internal superheating section of the extruder apparatus which is downstream of the feed port and is at least about four times the diameter, 4D, of the hollow member; and wherein the extruder apparatus is operated at a devolatilization performance ratio (DPR) which ranges from about 0.01 to about 200 wherein the devolatilization performance ratio is the feed rate (FR) divided by the screw speed (RPM) according to the equation
DPR=FR/RPM

29. The method according to claim 32, wherein the polymer product comprises a polymer selected from the group polyetherimides, polyimides, poly(arylene ether), polyethersulfones, polycarbonates, polycarbonate esters, polyamides, polyarylates, polyesters, polysulfones, polyetherketones, polyimides, olefins, polysiloxanes, poly(alkenyl aromatic) polymers and mixtures thereof.

30. The method according to claim 28, wherein the polymer product comprises a polyetherimide polymer having a concentration of residual solvent ranging from more than 0 to less than 500 ppm, and D is at least 10 millimeters.

31. The method according to claim 28, wherein the superheated polymer-solvent mixture has a temperature ranging from greater than about zero to about 200° C. higher than the boiling point of the solvent at atmospheric pressure.

32. The method according to claim 28, wherein the polymer-solvent mixture comprises less than or equal to about 45 percent by weight polymer, based on a total weight of the polymer and the solvent.

33. The method according to claim 28, wherein the extruder apparatus further comprises at least one side feeder wherein the side feeder comprises a vent operated at a pressure of at least about 400 millimeter of mercury of absolute pressure or greater.

34. The method according to claim 28, wherein the extruder is selected from the group: a twin-screw counter-rotating extruder, a twin-screw co-rotating extruder, a single-screw extruder, and a single-screw reciprocating extruder.

39. The method according to claim 28, wherein the extruder is a twin-screw, co-rotating intermeshing extruder.

40. The method according to claim 28, wherein the solvent is selected from the group of halogenated aromatic solvents, halogenated aliphatic solvents, non-halogenated aromatic solvents, non-halogenated aliphatic solvents, and mixtures thereof.

41. The method according to claim 28, wherein the isolated polymer product comprises residuals selected from the group consisting of more than 0 to less than 100 ppm hexaethylguanadinium chloride (hegcl) (0 to 100 ppm), more than 0 to less than 50 ppm pentaethylguanandinium, more than 0 to less than 500 ppm orthodichlorobenzene, more than 0 to 500 ppm veratrole, more than 0 to less than 700 ppm chlorophthalamide, more than 0 to less than 700 ppm phthalamide, more than 0 to less than 50 ppm bisphenol A, and combinations thereof.

42. The method of according to claim 28, wherein the polymer-solvent mixture introduced into the extruder contains a filler.

43. The method according to claim 28, wherein the filler is selected from the group consisting of silica powder, talc; glass fibers; carbon black; conductive fillers; carbon nanotubes; nanoclays; organoclays, and combinations thereof.

44. The method according to claim 28, wherein the pressure of the forward flash volatilization port ranges from about 700 to about 800 millimeters of mercury and the pressure of the back flash volatilization port ranges from about 700 to about 800 millimeters of mercury.

45. The method according to claim 40, wherein the extrusion apparatus further comprises a surface renewal section downstream of the internal superheating section and a trace devolatilization vent port downstream of the surface renewal section, and wherein the pressure of the surface renewal section ranges from greater than zero to about 400 millimeters of mercury.

46. The system of claim 1, wherein the system is an extruder apparatus comprising:
a feed delivery system and a feed port,
a hollow member having a first end portion and a second end portion, the hollow member having a diameter D; and
at least one screw extending from the first end portion to the second end portion of the hollow member, wherein the hollow member contains at least one open section and at least one closed section and the hollow member is mechanically connected to the feed delivery system;
at least one vent insert located on at least one open section of the hollow member, wherein the at least one vent insert is dimensioned to (i) impart a clearance between the at least one screw and the vent insert (ii) shroud a screw upturn, and the at least one vent insert has an at least one inner surface having a curvature that is substantially similar to the curvature of the hollow member, and wherein the at least one vent insert has at least one opening that is sufficient to allow solvent to exit the hollow member during operation of the extruder while maintaining polymer in the hollow member;
a close coupled flash valve mounted on the feed port of the extruder apparatus;
an internal superheating section, having a length that is more than four times the diameter, 4D, of the hollow member located between the flash valve and at least one open section;
a downstream section, located between (i) an open section that separates the internal superheating section and (ii) the second end portion of the hollow member; and
a purge delivery system located at an open section of the hollow member, wherein the hollow member has an opening for receiving purging material from the purge delivery system.
